(19) United States
(12) Patent Application Publication
(10) Pub. No.: US 2025/0165638 A1
(43) Pub. Date: May 22, 2025

(54) System and Apparatus for Transforming an Electronic File Into Protected View Designed to Discourage and Identify Leakers

(71) Applicants: Zafar Khan, Redondo Beach, CA (US); Terrance Tomkow, Los Angeles, CA (US)

(72) Inventors: Zafar Khan, Redondo Beach, CA (US); Terrance Tomkow, Los Angeles, CA (US)

(21) Appl. No.: 19/023,095

(22) Filed: Jan. 15, 2025

Related U.S. Application Data
(63) Continuation-in-part of application No. 18/134,480, filed on Apr. 13, 2023.
(60) Provisional application No. 63/363,014, filed on Apr. 14, 2022.

(51) Int. Cl. G06F 21/62

(52) U.S. Cl. CPC G06F 21/6218

(57) ABSTRACT

An electronic document transformation and sharing system and apparatus that allows a document originator control over an electronic document shared with at least one recipient. An input device receives an original electronic document and associated document-specific controls instructions. By transformation, a new encrypted transformation document with embedded transaction ID and controls instructions is created from an original electronic document. A recipient, if authorized, may view the encrypted transformation document after decryption within the limits set by the controls instructions. For each authenticated authorized viewer, their unique identity authentication information is made visible to them in the form of covert and/or overt markings to deter the authorized viewer from leaking the information. In the event of a leak, the system enables identification of the authorized viewer responsible for the leak, even if the leak is propagated using a photo of a viewing screen where the protected and controlled document is displayed.

### FIELD

This invention relates to the field of Information Rights Management (IRM), specifically in the subsectors of Electronic Digital Rights Management (EDRM) and in its subsectors of Electronic Document Rights Management and Document Security, as well as the field of Data Leak Prevention, Data Security, and Content Security.

### BACKGROUND

There is a category of information rights management or digital rights management software applications that are designed to add controls to a file (e.g., message, document, image, media, structured or unstructured data display in an application) or content displayed on a browser of a device application such that the original document owner may control file access, for instance by revoking or expiring the file, encrypting files, or doing other things to the file to prevent the file from being shared deliberately or mis-sent to an unintended recipient. Products that do this can apply rights controlled access, identity controlled access, block distribution, or use other such techniques to prevent data leaks.

These systems are usually part of Data Leak Prevention (DLP), Digital Rights Management (DRM), Perimeter Security, Email Encryption, Data Room, or File Share applications, or information on systems on “air-gapped” networks (e.g., networks of computers that are not directly connected to the Internet or systems external to the organization). Some of these applications restrict printing.

Some of these aforementioned technologies have become ubiquitous within businesses dealing with sensitive information. For instance, these technologies may be operable to restrict functions such as printing, keyboard screen capture, and forwarding, with an aim to prevent an authorized viewer from sharing the information with unauthorized viewers. However, none of these technologies have the ability to reduce the risk of an authorized viewer taking an image of the content on the screen and then sharing that photo of the protected content with unauthorized viewers. This can for instance be achieved by a screen capture with a third party application, a camera, or a phone camera photo (referred to herein as a screen photo).

What is needed is a way to (a) deter viewers of a document from taking screen photos of protected content and leaking those photos to those who are not authorized by the originating content owner to view the content, for example, to view the content outside of the controlled systems, and (b) if a screen photo is taken and the photo is leaked and shared in a legal proceeding or other leak investigation, to provide the original content owner with a means for identifying the identity of the original leaker based on information associated with the screen photo taken. More specifically, this information would reach beyond simply looking at camera metadata from the photo, as the person taking the screen photo and leaking that photo may have disabled capture of phone or camera metadata from the photo before leaking the resulting photo.

It is therefore an object of the invention to provide an electronic document system or an apparatus that can extend one's existing document repository or document management system that overcomes the aforementioned shortcomings in the art. This object is achieved by the various embodiments of this disclosure (“RDocs ID Leakers”), which overcomes these challenges by use of its inventive RPD (“Rights Protected Document”) file construct in which the security and controls that the Originator prescribes are built into the RPD file itself. The RPD file may then be displayed to readers as an .HTML file, which may be openable in any browser or .html file viewer, as described in U.S. patent application Ser. No. 18/134,480 which is herewith incorporated by reference. Further, the object is achieved by the steganographic feature further described in this disclosure, wherein the steganographic feature can identify leakers that use a screen photo method of leaking by way of dynamically adding overt and covert markings to the document in a unique manner described in the invention. Those overt and covert markings are visible to the authorized viewer to discourage screen photo sharing of the protected content with unauthorized viewers, and provide evidentiary value in identifying the origin of the unauthorized dissemination of the document.

### SUMMARY OF THE INVENTION

It is an object of the invention to generate authorized reader identity markings to track an unauthorized individual who captures and leaks a photo. RDocs empowers originators with actionable proof identifying those who disclose sensitive content or, for example, restricted content under non-disclosure agreements. This is accomplished by using steganography, namely steganographic, dynamic and in-motion watermarking (“ID Leakers” aka “Identify Leakers”) that is uniquely identifiable to each authorized recipient. Uniquely applied to RDocs, this option can also restrict viewing to the authorized reader's initial reading IP-based geo-location, and can additionally add authorized reader visual identity tags that traverse each viewed page. These visual identity tags may include covert tags generated by a cipher of authorized authenticated viewer/reader identity information and/or overt tags generated by the actual authorized authenticated viewer/reader identity information. Readers visually see that if they were to share a snapshot of any one page or part of a page, they would be at risk of the leak being easily traced back to them with the Overt tags. Further, if they try to circumvent the Overt tags, the Covert tags can identify the leaker after-the-fact by deciphering the Covert tags encoding of the authorized authenticated viewer identity information. As a result, RDocs not only discourages unauthorized sharing, but can further provide court-admissible proof of who shared any unauthorized snapshot of a document. Notably, both the Overt and Covert tags are visible to the viewer and would be visible in a photo of a screen of the information viewed. Overt tags differ in that the Overt tags are readable by the authenticated, authorized viewer as their identity information, whereas the Covert tags are a cipher of this authenticated, authorized viewer as their identity information. Accordingly, the cipher masks which parts of the Covert tags are related to this identity information, where it starts and stops, and which cipher symbols would be needed by the system to identify after-the-fact the identity of the authenticated, authorized viewer who leaked the information via a screen photo.

It is a further object of the invention to provide a system and a method allowing an originator of an electronic document that has taken measures to retain control over this document (or display view of an application) even after sharing said document with one or more recipients. Then, if those measures are attempted to be circumvented by way of taking a screen photo of content, the originator is able to (a) deter a leaker from taking the photo with overt markings dynamically made identifiable to that particular viewer, and (b) forensically identify a leaker if the leaker shares with another party and that copy is later seen.

According to a first aspect of the invention, an electronic document transformation and sharing system is provided, allowing a document originator control over an electronic document shared with at least one recipient, said system comprising: an input device configured to receive at least one original electronic document; a web server; a database on said web server, configured to store an identifier for each document received by the input device; a data transmission subsystem transmitting to at least one recipient an information link identifying the document; a viewer configured to display images in standard formats; a verification subsystem at the server for executing an electronic transformation document viewer identity authentication process, said verification subsystem configured to: receive from the recipient a recorded string of identity data associated with the authenticated viewer at the database on said web server; and generate authentication information representing the string of identity data associated with the authenticated viewer, and a document transmission subsystem, said document transmission subsystem configured to: receive requests to view identified documents; respond to requests to view a document by singularly returning an image of each requested page of the original document, and return the identity authentication information displayed on each image of each page as it is viewed at the viewer.

According to a second aspect of the invention, an electronic information sharing system is provided, allowing an information controller control over an electronic information or document shared with at least one recipient, said system comprising: an electronic transformation information viewer configured to generate authentication information representing a string of identity data associated with the authenticated viewer, said electronic transformation information viewer configured to display images in standard formats; a web server; an input device configured to receive a representation of an authenticated information viewer identity; a database on said web server, storing an identifier for each authorized viewer; a transmission subsystem configured to: receive inputs from file requests to view identified file information; respond to file requests to view an information by singularly returning (i) an image of each requested page of a document, or (ii) a display of data for each request to view the information, and return to the electronic transformation information viewer singularly an image of information with the identity authentication information displayed on each image of each page as it is viewed at the viewer.

According to a third aspect of the invention, an apparatus is provided for receiving identity authentication information related to a viewer of an electronic file and transforming the viewer experience of the electronic file using received identity authentication information, the apparatus comprising: an input device configured to receive: identity authentication information associated with a prospective authorized authenticated viewer of an electronic file, and the electronic file designated for viewing by the prospective authorized authenticated viewer, a server with a database for storing the identity authentication information for each prospective authorized authenticated viewer; and a processor configured to perform at least the functions of: combining the identity authentication information representative of the prospective viewer with the electronic file, and displaying the electronic file with the identity authentication information representative of the prospective authorized authenticated viewer to the authenticated viewer.

According to a fourth aspect of the invention, a system is provided configured to receive identity authentication information related to a viewer of an electronic file and transform the viewer experience of the electronic file using the received identity authentication information, the system comprising: an input device configured to: receive identity authentication information associated with a prospective authorized authenticated viewer of an electronic file, and receive the electronic file designated for viewing by the prospective authorized authenticated viewer, a server with a database on said server for storing the identity authentication information for each prospective authorized authenticated viewer; a processor configured to perform at least the functions of: combining (i) the identity authentication information associated with the prospective authorized authenticated viewer with (ii) the electronic file, and displaying the electronic file with the identity authentication information to the authenticated authorized viewer.

According to one embodiment, the overt markings may include email address, telephone number, or other identity string authenticated to be associated with the authorized viewer. Since the goal of the overt markings is to deter the authorized viewer from taking the screen photo to share in an unauthorized manner, these markings in this embodiment may be configured to move and float over the document visible enough to make it obvious to the would-be leaker that a screen photo would display the identity of the authorized viewer. Thus, the authorized viewer would be discouraged from engaging in the act of leaking, because if the leaked screen photo was discovered by others, the authorized viewer would see and believe that their identity would be easily associated with the leak.

The covert markings may be optionally to be added according to another embodiment. These covert markings may be symbols having different sizes, where the different size symbols are the result of a cipher output of an encoded version of identifying indicia such as an email address, telephone number, or other authenticated identity string of the authorized viewer. The role of the covert markings is that if a leaker attempted to use technology tools to remove the overt markings (or some of the covert markings), the leaker would face difficulties in removing a sufficient number of the covert markings to thwarting the originator from identifying the leaker. This is because the system would be able to reverse the cipher and determine the leaker's identity with even a small portion of a screen photo.

Samples of viewer experience with overt markings moving and floating over the page and covert markings symbols embedded into the page displayed in an exemplary document viewer interface are shown FIGS. 19-22.

It should be noted that an authorized viewer could memorize content and then at a later time transcribe protected content from memory into another medium. Accordingly, the present invention is particularly suitable for discouraging leaks where the content of the protected information would want to be displayed in its native format, so that the unauthorized viewer would have a sense of the authenticity of the leaked content.

It is important to note that these markings are not a “watermark”, as a watermark is associated with the document and is static with the document. In contrast, the covert and overt markings are dynamically generated by this invention, and the markings are unique on each viewed page at the time of viewing. According to certain embodiments, the markings may change based on the viewer and/or page viewed, and may even change if there is a future authorized viewer added after the original document has been generated. Moreover, the overt markings differ from watermarks in that the overt identity markings are moving and floating on the viewer's viewing screen as an overlay on the document, and these movements are likewise unique to the identity of the authenticated authorized viewer in that document viewer session, as opposed to being static with the document like a watermark. Additionally, the covert identity markings are unique to the identity of the viewer in that document viewer session and may be unique to each page.

This invention is configured to provide for the dynamic application of these markings unique to each authenticated authorized viewer, and potentially each authenticated authorized viewer viewed page. The markings may be built into the document either (i) after the document has been generated in the protected form, (ii) after sharing, (iii) after viewer authentication has been affirmed, or (iv) before the document is viewed by each authenticated authorized viewer.

### DETAILED DESCRIPTION OF THE INVENTION

Within this field, the disclosure relates to a system generally that empowers (a) holders of electronic files and documents to distribute such files securely to third parties, while keeping the original holder (“Originator”) in full control over each document, its content, and access rights; even after sending, or (b) systems that build electronic files and documents to distribute such files securely to third parties (such as output management systems or software), while keeping the original holder or the Originator administrator (“Originator”) in full control over each document, its content, and access rights; even after sending.

The disclosure further provides a means for intended readers to access document content without any special companion software that is not native to most common business computing devices, namely providing a means for intended readers to access document content within their native browser. Importantly, the various embodiments of this disclosure do not require any intended reader to have any special companion software or browser settings that are not typical, nor have any plug-ins, or reader accounts. The functionality prescribed by the various embodiments of this disclosure is a system that includes the system server, input and output devices, and an encrypted transformation document created from the original electronic document such as a PDF file, in the following also named RPD file, generally provides a means for:
1. Intended readers to access document content without any special companion software that is not native to business workstation computing devices, namely providing a means for intended readers to access document content within their native web browser. Importantly, the various embodiments of this disclosure do not require any intended reader to have any special companion software or browser settings that are not typical, nor have any plug-ins, or reader accounts;
2. Originators to revoke access temporarily, or to permanently kill a document entirely, even after delivery, including all traces of the transaction;
3. Originators to deliver these documents directly to each recipient, without any third-party storage of documents in the period between the send and the retrieval by the recipient; and Some exemplary applications where an Originator may reap advantages from distributing content as RPD files instead of as PDF files include:

Publishers of subscription research reports and financial tip newsletters who send their content as PDF files risk readers sharing the fee-based content with others without a licensed. If sent as an RPD file, sharing can truly be disabled, controlled, and tracked. Corporate executives and company secretaries share non-public corporate, board or shareholder reports as PDF files or via encrypted email with PDF files attached. Once sent, they risk readers sharing the business-sensitive content with others. If sent as an RPD file, sharing can truly be disabled, restricted to viewers within the Originator designated company, voted on in-the-document, killed after usefulness, and view-time tracked.

Transactional closing purchase agreement documents, which often include funds transfer information, are often shared as PDF files. As an added layer of protection for mitigating wire fraud risk through wire instructions intercepted and modified to cause mis-wires, documents sent related to financial closings or transfers could be sent as RPD files with viewing restricted only to viewers within an IP-geo-location and within the domain of the intended party.

Invoices are often sent individually or from Output Management systems are sent as PDF files attached to email and are susceptible to forgery by those monitoring emailed invoice transmissions. Invoices could be generated to only be viewable within the organization of the intended payee (by IP range of the intended viewer, IP-geo-location and/or domain).

Agreement sent for final review related to transactions that are highly sensitive, are often sent as PDF files or via encrypted email, or sometimes as scans of a print out of a PDF for perceived extra authenticity protection. RPD files are preferred to ensure no undetected edits could be applied, and to ensure privacy of the information tied to a user with the sensitive information viewable only by the designated viewer.

RDocs, and its RPD files, are configured for rights protected controlled document distribution. In other words, RPD files are intended to be used for final distribution of content that is not intended to be edited by readers, or which the Originator intends not to make editable. However, unlike PDF files where edits made using a PDF editor may be undetectable, RPD files are specifically designed to preclude undetectable edits, even if users have PDF editors or use photoshop or other programs.

The Originator's RPD file send/creation history pane becomes the Originator's control panel for each document. In addition to its functionality for managing the access and protections for the RPD file, it also for the Originator to view insights or feedback related to each reader/viewer. The RPD “SideNote®” and “Doc Vote™” features within the RDocs™ service are designed to showcase how messages may be embedded inside documents and how likes, dislikes—or other interactive elements—can be built into documents with real-time feedback loops and real-time data analysis of insights presented to the Originator. RPD files makes it easy to build real-time document-centric interactivity into file sharing, email, or instant messaging platforms, wherein all platforms share a common format. Ultimately, pushing a message inside an HTML email wrapper may be similar to pushing a message inside an HTML file (an RPD file wrapped in the HTML wrapper). RPD files are packaged in HTML format so there is no need for any companion software; viewing access for readers is as ubiquitous as are web browsers. RPD files allow users to simply click to open an RPD file, and the file opens for viewing in any browser. Finally, the RPD in-document interactivity, brings document-centric email closer to the functionality of instant messaging interactive platforms.

Further to the described embodiments, various aspects of the invention including the receiving of the encrypted package including the document from the viewer to the system server, the preparation of the document to display to the viewer, and the transmission of the document page to the viewer are further described below:

(A) Pre-process to create the encrypted package to transmit
The original sent document pre-processed into a standard document format to speed up future imaging processing plus the original sent control instructions and the transaction document ID generated at the time of pre-processing are encapsulated within the encrypted content received.

After the click to open the RPD at the viewer:

(B) Prepare at the system server
Document ID and some metadata, which may include recipient/reader email address based on control instructions, is passed from viewer to system server
if document is killed based on originator rules or expired, max authorized or remaining reads per reader are exceeded, no further units are available, or access is otherwise not authorized by location, etc. as determined from passed metadata and Doc ID lookup compared to controls in the database at the system, then system sends message to viewer to display message document not available.
if document is alive based on originator rules or can be permitted to be viewed, then the system server identifies if the document is required to limit viewers or track who is viewing (via authenticating the requesting viewer with a list of authorized viewers of the document the list being at the server, or if no viewing restrictions but viewer tracking is required based on document controls at the server, then sends signal to the viewer to authenticate the requesting viewer. The viewer authentication can be through email authentication, SMS/text authentication, or other user device login or multi-factor, one time passcode, or other authentication method). Once the requesting viewer is authenticated, the authenticated identity (email address, SMS number, digital ID, device login ID, etc.) is passed to the server.
if document is (by originator rules) alive or can be permitted to be viewed by this authenticated viewer, then the system server sends signal to the file at the viewer for the file at the viewer (note, this happens programmatically without viewer action) to transmit the document (encrypted document package that contains the document and full metadata of controls information and document ID) to the system server.

(C) Re-transmit content to authenticated authorized viewer for viewing

At server upon receipt of the encrypted document package:
encrypted document package is decrypted
document is prepared based on the controls information, with preparation to at least include:
creating an image of each page of a subset of pages
encoding the authenticated identity using a cipher or otherwise, to create a Covert Code related to the identity of the specific authorized viewer
delivering the image of the viewer requested page to view to the viewer (only that page), and embedding the covert code on the image in multiple locations with different color schemes like a watermark dynamically generated and unique for that authorized authenticated viewer for the specific page,
holding the other imaged pages in memory at the server prepared with the Covert Code markings or prepared ready to append the covert code markings, when the viewer opts to view another page.
if the viewer opts to view a page that has not yet been put in image, then that requested page and pages surrounding are imaged to speed up the viewer experience while switching pages
that requested page is delivered to the viewer with the Covert Code markings embedded.

At the viewer in the viewing application (e.g., web browser) the overt identity markings display in a different pattern with movement across the screen,

At the viewer, the file metadata further instructs by the server to the viewer application not to cache images (not store in memory at viewer).

An expert skilled in the art would understand that this Covert Code can be included with the Overt markings, or only one of the covert or overt markings could be included individually. Covert and Overt markings could take different forms, including varying parameters such as density, movement speed, no movement, colors, shapes, sizes, etc. These parameters could be adjustable by the originator or by an administrator for the originator.

An expert skilled in the art would understand that these capabilities are also available to be added to a document management or document storage system that would operate the process of adding the covert and/or overt markings to the document in a process between where the document is stored and where or how it is displayed in a viewing application for an authorized authenticated viewer.

An expert skilled in the art would understand that the covert code transforms the authorized authenticated viewer identity information into various shape sizes and forms. This transformation masks from the authorized viewer, or from those who have received the leaked information, which parts of the covert markings contain the details needed by the system to decipher who the original leaker was. More specifically, who the original authenticated authorized viewer was who leaked that particular version of the document through, for example, a screen photo.

An expert skilled in the art would understand that these described capabilities are also available to be added to a viewer of application data (e.g., a browser or other proprietary viewer or application data) where the identity of the viewer is based on their log-in access to the application or device. The markings may be displayed as an overlay on the browser, via an add-in to the browser or other viewer application, or dynamically generated and displayed by the application viewer software. In this embodiment, an application data viewer would first authenticate to gain access to the device with the application or the application itself. An example application would be an enterprise resource management system or performance or key performance indicator application dashboard displaying database information in a structured manner visualized in charts and tables. This information may be confidential to the organization holding the underlying data or operating the application. This data owner would utilize the present invention to deter viewers from taking screen photos of the visualized data and then leak that data to people not authorized by the data owner to see the information. In this embodiment, the invention includes an apparatus for receiving identity authentication information related to a viewer of an electronic file, where the file may for instance include the visualized data from the application database. The apparatus may also be configured to transform the viewer experience of the electronic file using received identity authentication information from the device access or application access login. The apparatus may comprise an input device configured to receive the identity authentication information associated with a prospective authorized authenticated electronic file viewer, along with the electronic file, structured, or unstructured data designated for viewing by the prospective authorized authenticated viewer. A server may be included with a database for storing the identity authentication information for each prospective authorized authenticated viewer. The embodiment may further include a processor configured to perform at least the functions of combining the identity authentication information representative of the prospective viewer with the electronic file, and displaying the electronic file with the identity authentication information representative of the prospective authorized authenticated viewer to the authenticated viewer.

The combined identity authentication information representative of the prospective viewer being converted into a cipher, and representation of the cipher that is unique to the prospective authenticated viewer may be displayed to the authenticated viewer in the form of covert markings that are visible but coded. Additionally or alternatively, the identity authentication information may be converted into a visible authenticated viewer identity string unique to the prospective authenticated viewer, and optionally also for the identity authentication information associated with the prospective authenticated viewer. The covert markings may be represented by at least one of letters, numbers, and symbols having varying sizes, densities, and colors, and the overt markings may be represented by at least one of letters, numbers, and symbols having varying sizes, densities, and colors, wherein the overt markings dynamically float over the electronic file displayed in the viewer within the application. In this embodiment, the viewer authentication information could be passed to the server at login, and the overt markings could operate as an overlay on top of or within the data viewer application. In this embodiment, the authentication information could be passed to the service via an application programming interface (API) that would then store and generate the covert or overt codes that would then be passed by application programming interface (API) back to the application in a manner in which they would display as overt or covert codes floating on top of the application data in the application viewer.

### BRIEF DESCRIPTION OF THE DRAWINGS

The drawings accompanying in forming part of the specification are included to depict certain aspects of the disclosure. A clear impression of the various embodiments of the disclosure, and of the components and operation of systems provided within the disclosure, will be more readily apparent by referring to the exemplary, and therefore nonlimiting, embodiments illustrated in the drawings, wherein identical reference numerals designate the same components.

FIG. 1 is a schematic diagram of the components of a system for generating RPD files.

FIG. 2 is a flowchart of the functions of an RPD generation, controller and activity processing unit according to an embodiment of the present invention.

FIG. 3 is an exemplary Document Receiving Unit Interface shown with a corresponding partial schematic of the flow chart of FIG. 2, according to an embodiment of the present invention.

FIG. 4 is an exemplary Updated Instructions Input Interface shown with a corresponding partial schematic of the flowchart of FIG. 2, according to an embodiment of the present invention.

FIG. 5 is an exemplary Activity Data Display Interface shown with a corresponding partial schematic of the flowchart of FIG. 2, according to an embodiment of the present invention.

FIG. 6 is an exemplary Email Attachment Display Interface shown with a corresponding partial schematic of the flowchart of FIG. 2, according to an embodiment of the present invention.

FIG. 7 is an exemplary Encrypted RPD File Viewer Interface shown with a corresponding partial schematic of the flowchart of FIG. 2, according to an embodiment of the present invention.

FIG. 8 is an exemplary Opened RPD File Viewer Interface showing a view of a document in a RPD file that has been opened in a web browser, shown with a corresponding partial schematic of the flowchart of FIG. 2, according to an embodiment of the present invention.

FIG. 9 is the flowchart of FIG. 2, modified to identify groupings of the related steps.

FIG. 10 is a flowchart of the functions of an RPD generation, control and transmission system according to an embodiment of the present invention.

FIG. 11 is a flowchart of the system's authentication procedure when an RPD HTML document is attempted to be opened in a recipient's browser.

FIG. 12A is a cross-functional flowchart detailing an RPD creation and access procedure according to an embodiment of the present invention.

FIG. 12B is a cross-functional flowchart detailing an RPD creation and access procedure according to an embodiment of the present invention, supplementing the process shown in FIG. 12A with the steps of adding Steganography features.

FIG. 13 is a schematic diagram of a computer or processing system that may be specifically modified by the various embodiments of the present disclosure.

FIG. 14 is a schematic diagram of a network use in accordance with the various embodiments of the disclosure.

FIG. 15 is a simplified flowchart outlining the RPD creation and feature selection process according to an embodiment of the present invention.

FIG. 16 is a simplified flowchart outlining the RPD transmittal and authentication process according to an embodiment of the present invention.

FIG. 17 shows a comparison of features menus for respective security levels according to an embodiment of the present invention.

FIG. 18 shows a schematic flowchart of the process of an originator sending and processing of a document that has the Identify Leakers steganographic feature enabled.

FIG. 19 shows an exemplary document viewer interface including Identify Leakers with high density covert code markings and floating text overt markings according to an embodiment of the invention.

FIG. 20 shows an exemplary document viewer interface including Identify Leakers with covert code markings featuring different shapes according to an embodiment of the invention.

FIG. 21 shows an exemplary document viewer interface including Identify Leakers with covert code markings featuring different shapes according to an embodiment of the invention.

FIG. 22 shows an exemplary document viewer interface including Identify Leakers with covert code markings featuring different shapes and overt identity markings in the form of floating text.

FIG. 23A shows a schematic flowchart for the implementation of Identify Leakers to a document.

FIG. 23B shows a flowchart for introduction of ID Leakers comprising configurable shapes and floating text to a document.

These diagrams are describing some embodiments of the various embodiments of this disclosure, those skilled in the art will understand that there are other embodiments and more details within each of these embodiments not depicted in these diagrams. Those skilled in the art will understand that the sequence of actions shown in the Figures may be changed or bypassed without changing the overall objective of the invention.

### DETAILED DESCRIPTION OF THE PREFERRED EMBODIMENTS

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Detailed descriptions of known computer software, hardware, operating platforms, and protocols are omitted so as not to unnecessarily obscure the disclosure in detail. Various substitutions, modifications, additions and/or rearrangements within the spirit and/or scope of the underlying inventive concept will become apparent to those skilled in the art from this disclosure.

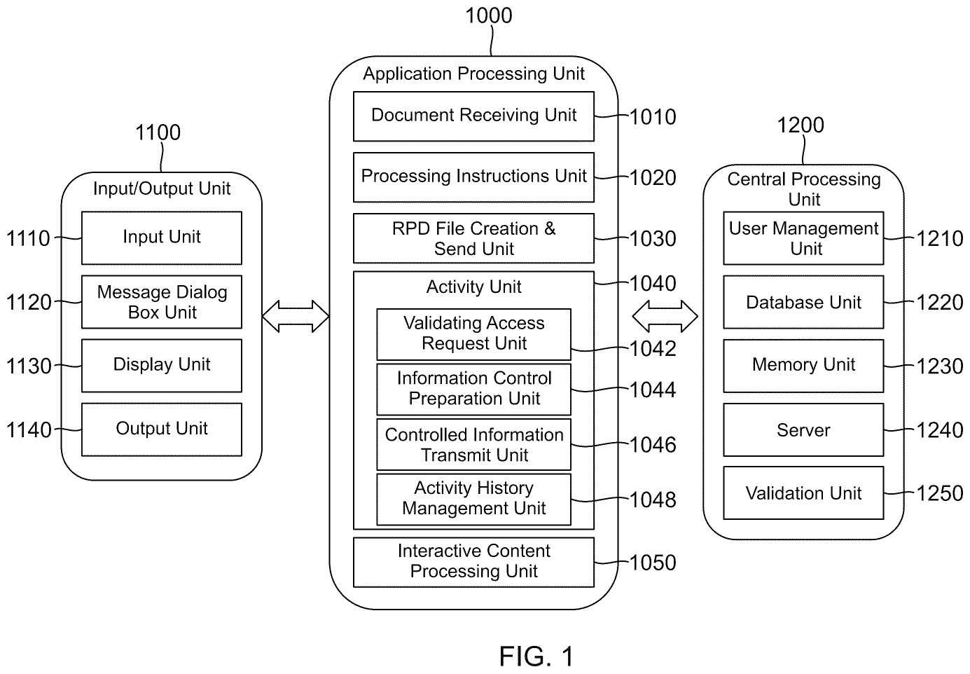

FIG. 1 is a schematic diagram of the components of a system for generating RPD files. The system comprises an Application Processing Unit 1000, an Input/Output Unit 1100, and a Central Processing Unit 1200. The Application Processing Unit 1000 comprises a Document Receiving Unit 1010, a Processing Instructions Unit 1020, a RPD File Creation & Send Unit 1030, an Activity Unit 1040, and an Interactive Content Processing Unit 1050. The Activity Unit 1040 includes various sub-units including a Validating Access Request Unit 1042, an Information Control Preparation Unit 1044, a Controlled Information Transmit Unit 1046, and an Activity History Management Unit 1048. The Input/Output Unit 1100 comprises an Input Unit 1110, a Message Dialog Box Unit 1120, a Display Unit 1130, and an Output Unit 1140. The Central Processing Unit 1200 comprises a User Management Unit 1210, a Database Unit 1220, a Memory Unit 1230, a Server 1240, and a Validation Unit 1250. Document Receiving Unit 1010 may be configured to receive the original document and any instructions corresponding to that document. Processing Instructions Unit 1020 may be configured to process the instructions received by the Document Receiving Unit 1010. RPD File Creation & Send Unit 1030 may be configured to create an RPD document using a creation process, apply controls instructions to the RPD, and transmit the RPD file by email or other means. Activity Unit 1040 may be configured to perform the functions of steps 41, 43, 44, and 46, relating to the collection and displaying of activity data, as well as validation functions. Interactive Content Processing Unit 1050 may be configured to process the interactive data (e.g. votes, feedback, engagement analytics).

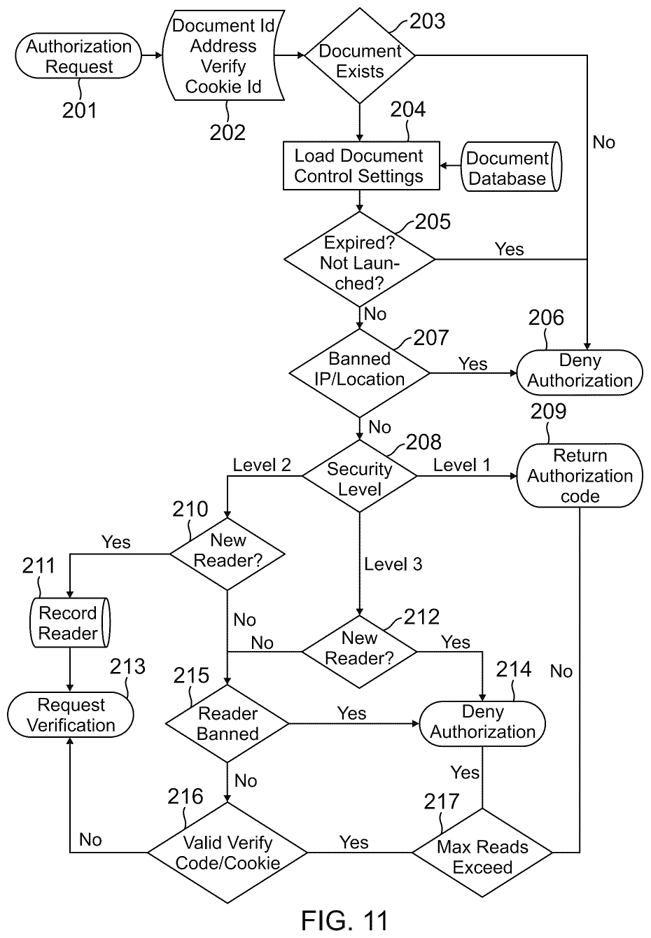

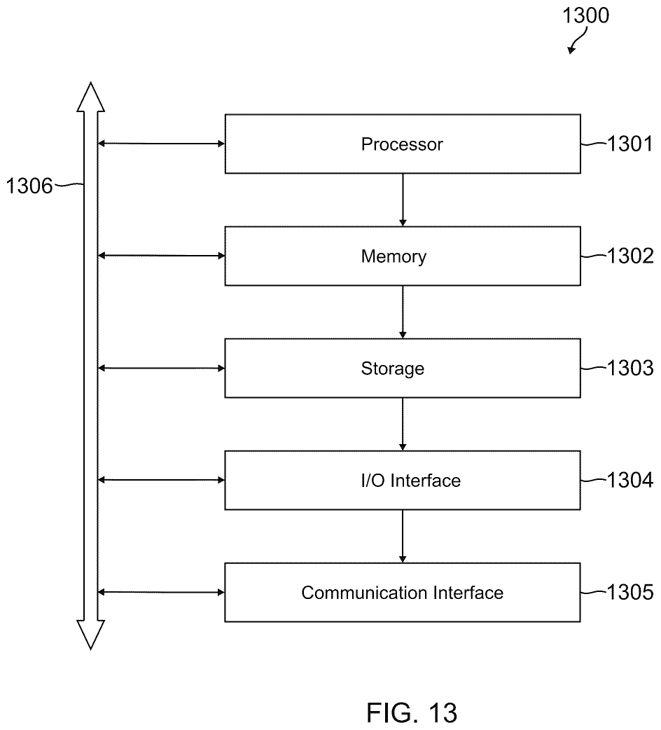

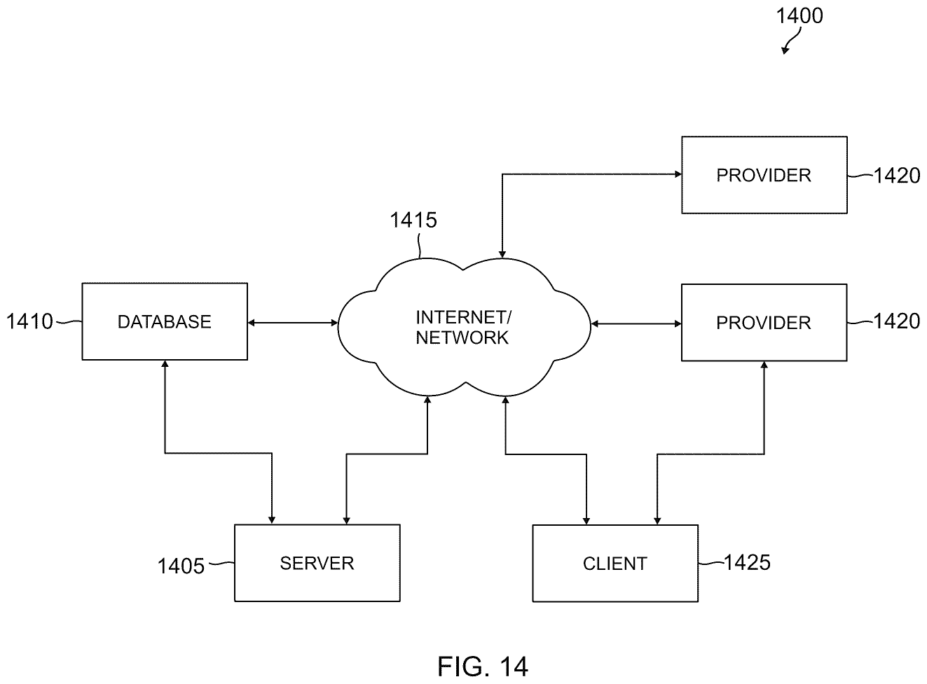

The Central Processing Unit 1200 relates to the elements of the computer system 1300 of FIG. 13 and the network of FIG. 14. User Management Unit 1210 may be configured to manage and control user accounts and activities relating to user access. The Database Unit 1220 may include one or more databases, for instance the Instructions Database 13, Activity Database 42, RPD File Database 18, and Session Activity Database 150. Memory Unit 1230 and Server 1240 may perform the functions of corresponding elements 1302 and 1405, as described regarding FIGS. 13 and 14. Validation Unit 1250 may be configured to perform functions relating to the validation of users, for instance the validation/authentication processes of FIG. 11.

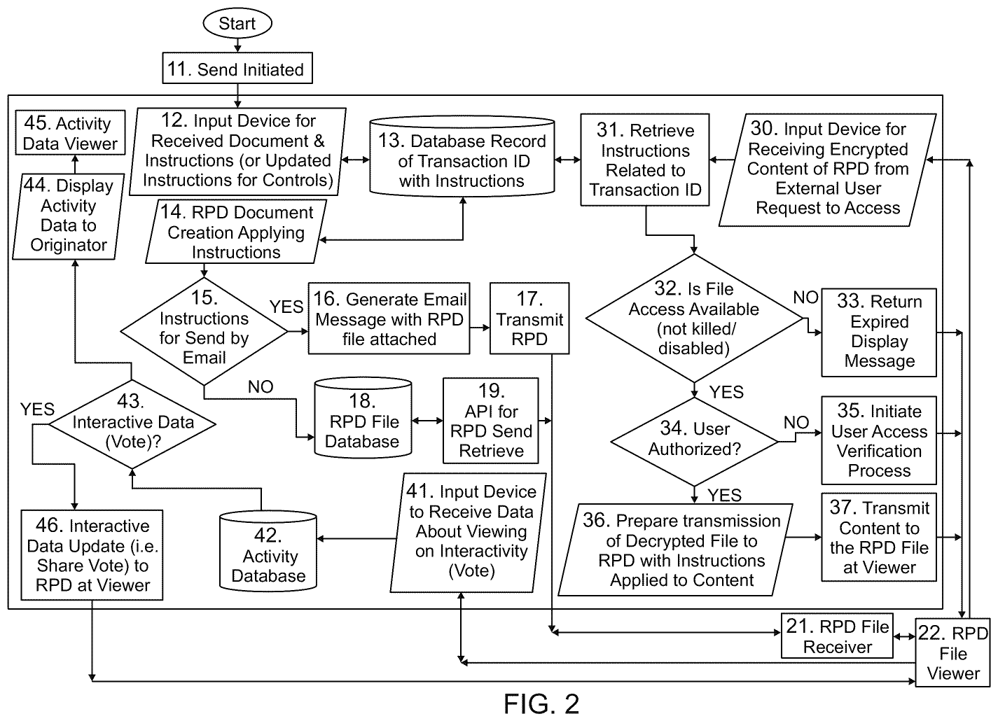

Input/Output Unit 1100 performs a variety of functions described in the processes of FIGS. 2, 10, 11, and 12. The Input Unit 1110 may be configured to receive inputs into the system, for instance data transmitted to the system or entered via an interface. Message Dialog Box Unit 1120 may output dialog messages. For instance, the Expired Display Message of Steps 33 and 133, and the Deny Authorization Message of Steps 206 and 214. Display Unit 1130 may enable display of various interfaces described herein, including the Document Receiving Unit Interface 300, Updated Instructions Input Interface 400, Kill Selected Button 410, Activity Data Display Interface 500, Email Attachment Display Interface 600, Encrypted RPD File Viewer Interface 700, and Opened RPD File Viewer Interface 800. Output Unit 1140 may be configured to provide outputs from the system.

FIG. 2 is a flowchart of the functions of an RPD generation, controller, and activity processing unit according to an embodiment of the present invention. The system may be configured to generate an RPD file, transmit the file, authenticate and display file information, receive activity data, and return interactive data into the viewer's interface. In step 11, the sending of a file is initiated. The send can be initiated, for example, using the system's web sender interface, where a document is uploaded and controls instructions are added associated with the document. In another embodiment, the documents may be submitted via API along with data file with controls instructions. In another embodiment, documents may be submitted via API and a pre-set controls instructions would apply. In yet another embodiment, documents may be submitted or sent via SMTP email routing, or other methods, such as a sender sending an email with attachments, and that email routes outbound through a data leak prevention system or server. The server identifies that there are attachments, and separates those attachments from the email, and transforms those attachments into RPD files by submitting them via API to a creation server. The API returns the transformed files, which are then re-attached to the email, and the email continues its routing to the recipient with the newly transformed attachments from original formats to RPD files. The party sending the file may be referred to as the Originator. The control instructions to be applied to the file may be specified by the Originator through the Document Receiving Unit Interface 300.

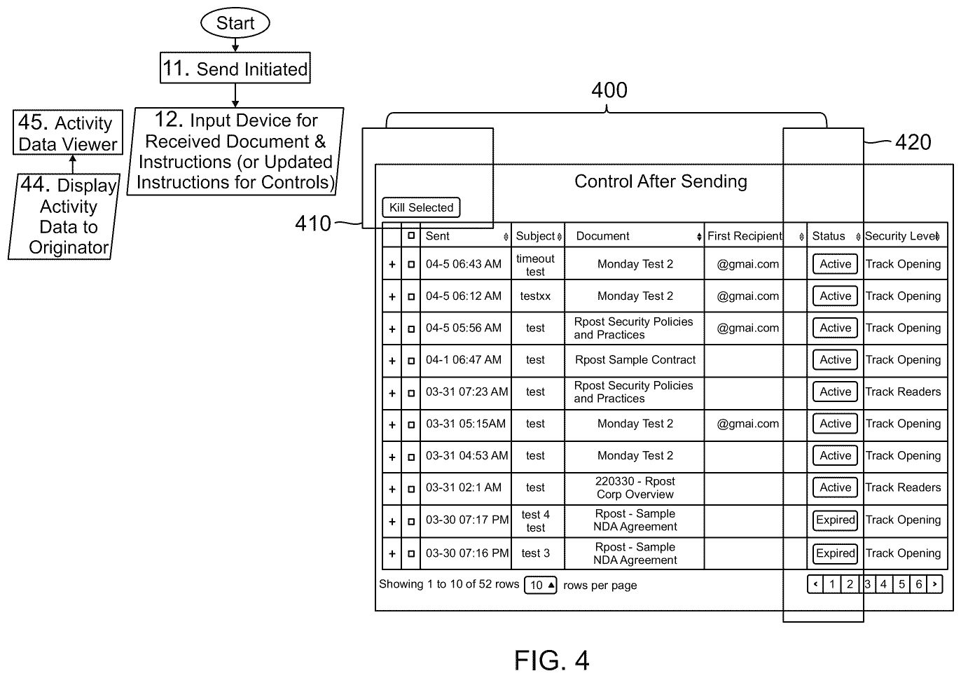

In step 12, the Document Receiving Unit 1010 receives the document and any instructions corresponding to that document. As an alternative to controls instructions, instead there may be an indication to use pre-set controls. For instance, if no control instruction file is included, the system may be configured to apply the most recently used control instructions as a default. In addition to the original instructions, the system may additionally be configured to update the instructions, such that they differ from the original instructions. These instructions may be entered into the Updated Instructions Input Interface 400 shown in FIG. 4. For instance, the updated instructions could be to kill a certain file, which may be achieved by clicking the Kill Selected Button 410.

In step 13, a database generates a transaction ID record associated with the document and stores the controls instructions in the database associated with the transaction ID.

In step 14, the RPD File Creation & Send Unit 1030 creates a RPD document using a creation process, and applies the controls instructions to the RPD.

In step 15, the Processing Instructions Unit 1020 determines whether the control instructions include directions to send the file to recipient addresses via email. If the controls instructions include such instructions, then according to step 16, the RPD File Creation & Send Unit 1030 generates an email with the RPD file attached. Subsequently, in step 17 the RPD File Creation & Send Unit 1030 transmits the RPD file by email. Otherwise, if the control instructions do not include such instructions, according to step 18 the RPD file is stored in a database, and in step 19, an API transmit the RPD file to a third-party system, or for a third-party system to use webhooks or other methods of retrieving the RPD file. If access to a RPD file is restricted, when it is retrieved, the document includes an indicator as to which email address(es) access is restricted to.

In step 21, the RPD File Receiver receives the RPD file, for instance via email, or if retrieved by API, then inside a third-party system. If the RPD file is sent via email, it may display to the RPD File Receiver as the Email Attachment Display Interface 600.

In step 22, a viewer may access the RPD file. The viewer may, for example, be a human, or a third-party system accessing the file. The RPD File Viewer may view the Encrypted RPD File Viewer Interface 700 or Opened RPD File Viewer Interface 800, depending on the status of the restrictions/verification.

In step 30, when the RPD file is opened, an input device receives an encrypted content package transmitted from the RPD File Viewer back to the system. This package may include preliminary metadata for the system input device to evaluate to determine the status of the RPD file (whether disabled, expired, etc.) before accepting the encrypted content package that contains the original file data.

In step 31, based on the encrypted content package, the system accesses the database of step 13 and retrieves the database record containing the controls instructions associated with the Transaction ID.

In step 32, the system determines whether file access is available, as opposed to being killed or disabled. If the file related to the Transaction ID has been killed, disabled, time-expired, or no record exists, according to step 33, the Message Dialog Box Unit 1120 generates a Return Expired Display Message and displays the message in the view interface of the RPD file. Otherwise, the system proceeds to step 34, where the system verifies if the user accessing the RPD file at the viewer is an authorized user. If the user is not an authorized user, according to step 35, the system transmits an instruction to the Message Dialog Box Unit 1120 to display a message to the reader indicating that the document is not available. Otherwise, if the user is an authorized user, according to step 36, the system prepares transmission of a decrypted file to RPD with instructions applied to content. Subsequently, in step 37, the system transmits content to the RPD File Viewer, such that the content of the RPD file may be displayed, for instance via the Opened RPD File Viewer Interface 800.

In step 41, the input device of the system may receive activity data related to the viewing from the RPD file at the activity input device. The activity data may comprise one or more data parameters associated with viewing and interactivity, such as the number of times viewed, minutes viewed, votes, likes, etc. In step 42, the Activity Database may record the received input activity associated with the Transaction ID.

In step 43 the system determines whether the input data includes Interactive Data, and if so, in step 46, the system captures updated interactive data and transmits it to the RPD File Viewer. The interactive data could, for instance, be a vote.

In step 44, all RPD file activity data is displayed via the Activity Data Display Interface 500.

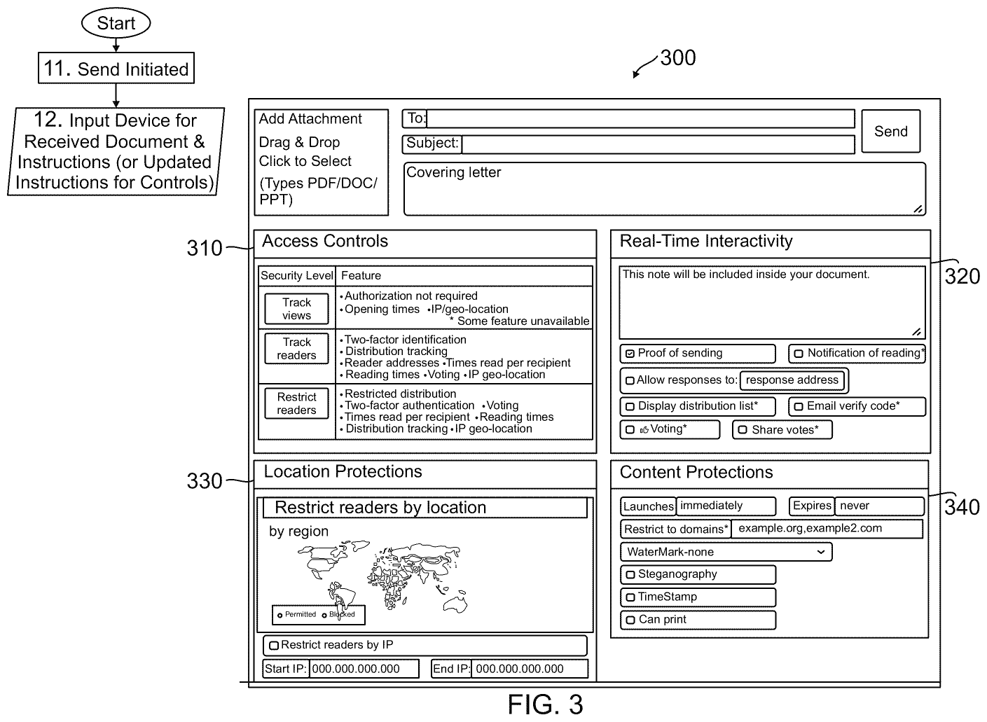

In step 45, the Originator views the activity data via the Activity Data Display Interface 500. FIG. 3 shows an exemplary Document Receiving Unit Interface 300 associated with the Document Receiving Unit 1010. In the context of the flowchart of FIG. 2, this interface is associated with entering controls instructions according to steps 11 and 12. The Document Receiving Unit Interface 300 comprises an Access Controls Module 310, a Real-Time Interactivity Module 320, a Location Protections Module 330, and a Content Protections Module 340.

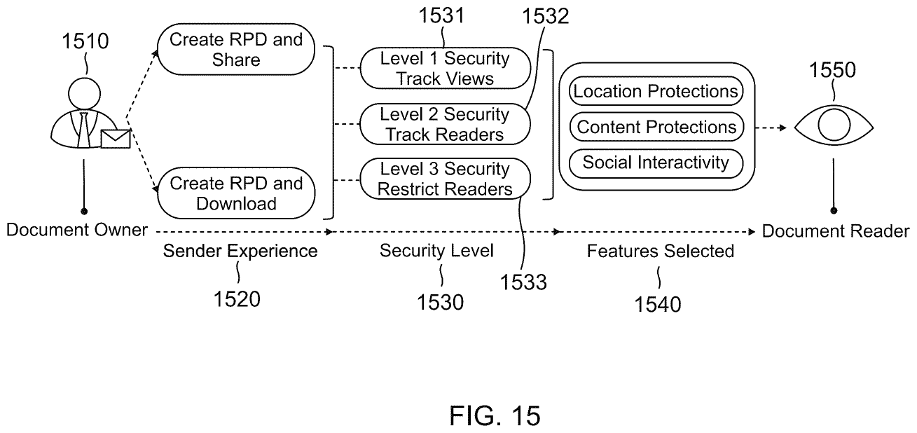

The Access Controls Module 310 enables a user to select a desired level of security for the document, including Level 1 Security: “Track Views”, Level 2 Security: “Track Readers”, and Level 3 Security: “Restrict Readers”, wherein each security level activates certain features for the monitoring and/or exclusion of readers. The features are discussed in greater detail regarding FIG. 15.

The Real-Time Interactivity Module 320 allows a user to select features associated with readers' interactions with the document, for example proof of sending, notification of reading, and voting functionalities. The document may track who views what, when and where, and for how long. Moreover, the present invention enables notes to be appended into the document, and may tally viewers votes, likes, dislikes, and feedback in real time. For instance, feedback may be returned in real-time as a viewer reads the document. This feedback may be in the form of “likes” and/or dislikes, which may be tabulated by the system and provide insights into the reactions of document viewers. This voting functionality may also be tied to text of a question related to the document with the option for viewers to like, dislike, and/or provide other responses. The feedback may be displayed to an Originator in real-time by means of a user interface. Exemplary features through which a Document Originators may opt to interact with their readers with real-time interactivity inside the document include: (i) short message sharing, (ii) short message responses, (iii) voting (likes and dislikes) in documents, (iv) record of agreement to content from indications in the content itself, (v) real-time vote tally and aggregation, (vi) real-time vote sharing with all voters, and (vii) more interaction and data flow from reader to Originator.

The Location Protections Module 330 allows a user to restrict access to the document based on geographical location, wherein an Originator sending an RPD attachment may restrict the geography where it can be viewed, or define the internet locations where it can be accessed, for example by reader domain, IP range, or geographic region. In one embodiment of the invention, the Document Originators can opt to restrict viewing to certain geographic locations by clicking regions on a digital interface of a world map, or limit to specific Internet locations based on a set start and end IP range (such as only within a country or within an Originator corporate or client corporate network).

The Content Protections Module 340 allows a user to add a variety of additional protective measures to a file. Furthermore, Originators may choose to rights protect document content by scheduling document initial viewing availability time and final viewing expiration time, or may apply additional advanced content protections to the document, including: (i) Restrict viewing within a web domain or set of domains, such as requiring a viewer to have a certain corporate email address, (ii) Watermarking the document with confidential or other visible marks, (iii) Timestamping the original document with a uniform time seal, (iv) Print restricting the original document, (v) Generating authorized reader identity-marking to track a photo-capturing leaker, and (vi) Killing a document and all of its traces. The Content Protections Module 340 may include an option to enable steganographic measures, which may be uniquely applied to an RPD to add authorized reader visual identity tags such as the authorized reader's email address that traverse each viewed page. Readers visually see that if they were to share a snapshot of any one page or part of a page, they would be at risk of the leak being easily traced to them. In this way, an RPD may provide steganography as a court-admissible proof of who authorized any unauthorized snapshot sharing. The purpose of this feature is to identify leakers. Document originators can opt to add steganographic or overt dynamic watermarks that are in-motion floating and uniquely identifiable to each authorized recipient. In the overt mode, readers visually see that if they were to share a snapshot of any one page or part of a page, they would be at risk of the leak being easily traced back to them. As a result, RDocs™ not only discourages unauthorized sharing (in the overt mode), but also can further provide court-admissible proof of who shared any unauthorized snapshot of a document (in steganographic or overt mode).

Through the Content Protections Module 340 of the Document Receiving Unit Interface 300, an Originator may also make a document self-destruct—also known as making the file inaccessible to any viewer or cryptographically locking it for all viewers—based on a variety of parameters such as on a timer or after a number of views, or my restrict sharing via print, copy, forward or photo.

FIG. 4 shows an exemplary Updated Instructions Input Interface 400 in which an Originator may input updated instructions. In the context of the flowchart of FIG. 2, this interface is associated with updating control instructions according to step 12, as well as the displaying of activity data on the Activity Data Viewer according to steps 44 and 45. In one aspect of the invention, an Originator may control or kill content after sending an RPD file, for instance if sensitive content is inadvertently sent to the wrong recipient. The Originator may kill the document, temporarily disable viewing, even after transmittal to a recipient, thereby allowing the Originator to retain total control of the document. The Originator can click to: (i) expire a document at will at a click of a button and toggle to disable and then re-enable viewing access at any time; and (ii) entirely kill a document, thereby killing all traces of its sending, distribution, tracking, and content, at any time even after the send. The updated instructions input may be integrated in the Activity Data Viewer, such that an originator may view in the Status Column 420 the current statuses of various documents contemporaneously to selecting which documents to kill. Once the desired selections have been made, the originator may kill the selected items by clicking the Kill Selected Button 410.

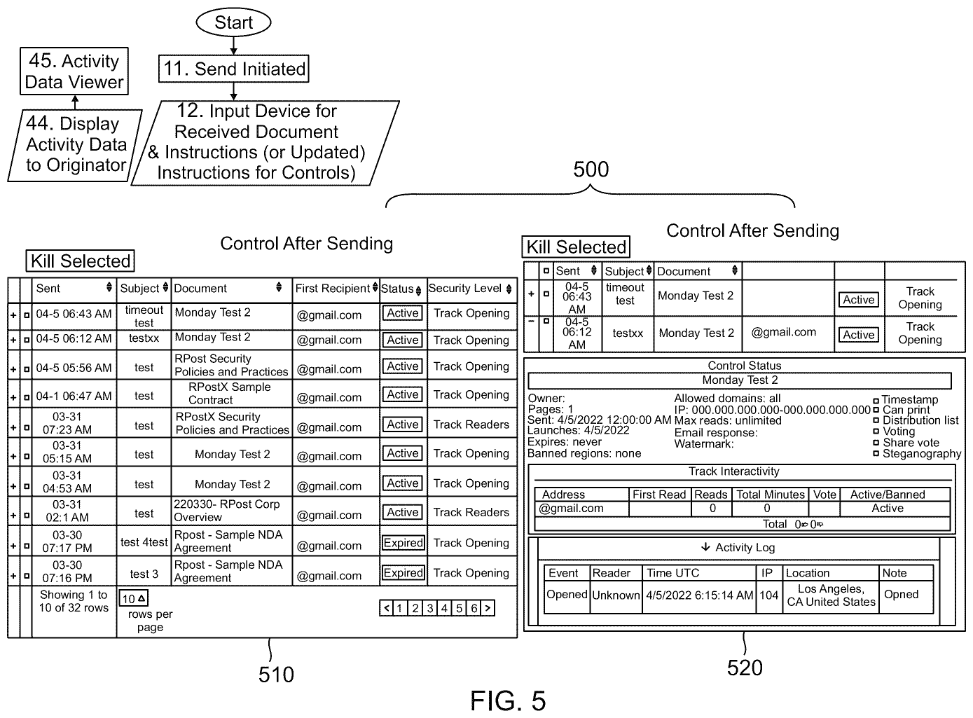

FIG. 5 shows an exemplary embodiment of an Activity Data Display Interface 500 in which activity data may be displayed to originator according to step 44 in the flowchart of FIG. 2. The Activity Data Display Interface 500 may comprise an Activity Data Table 510 and an Activity Data Profile 520. The Activity Data Table 510 may, for each record entry, include tabulated data with various columns including, for example, the date of sending, subject line, document name, email address of first recipient, status, and security level. Each record entry in the Activity Data Table 510 may be selected to display its Activity Data Profile 520, which may feature more detailed information about Track Interactivity and Activity Log. The Track Interactivity may keep a log of interaction data, such as the time of first read, the number of reads, minutes spent interacting with a document, votes, and status of the user. The Activity Log may keep a log of activity data, such as activity type, reader identity (if known), time and date of activity, IP address, and location.

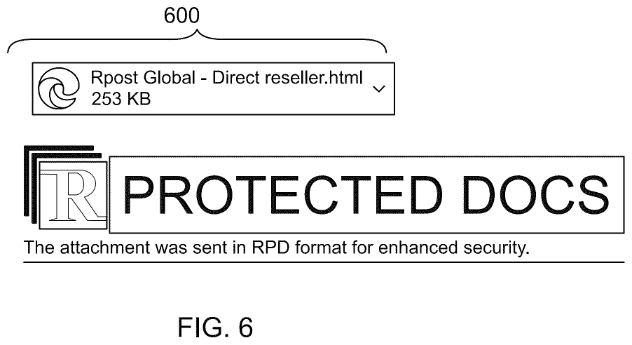

FIG. 6 shows an exemplary embodiment of an Email Attachment Display Interface 600 demonstrating how an HTML format RPD file may be displayed at the RPD File Receiver as an email attachment. This file may be opened to display, for example, one of: Encrypted RPD File Viewer Interface 700 or the Opened RPD File Viewer Interface 800, depending on the access status.

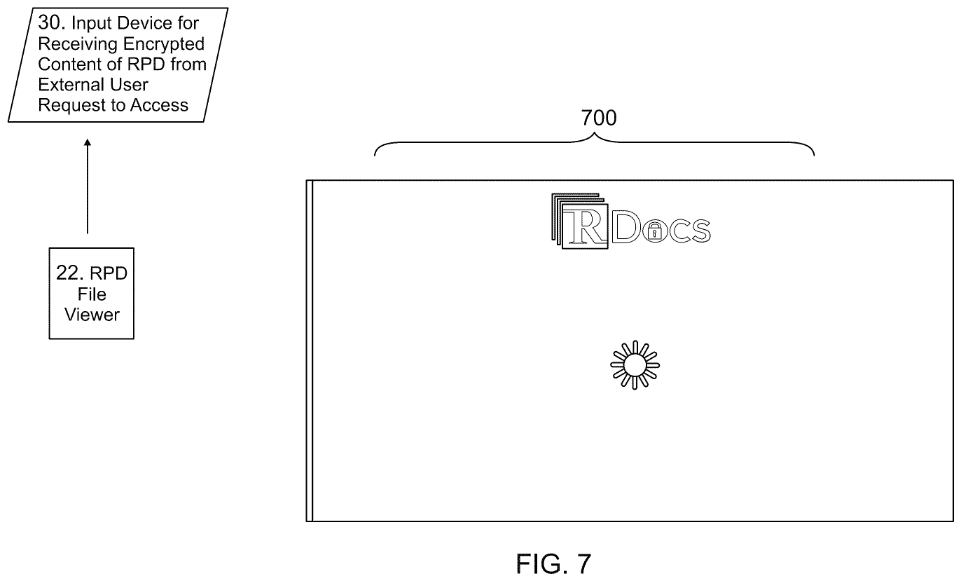

FIG. 7 shows an Encrypted RPD File Viewer Interface 700 corresponding to steps 22 and 30 of the flowchart in FIG. 2. The Encrypted RPD File Viewer Interface 700 may be displayed to a RPD File Viewer accessing the document in a web browser while the server retrieves records for an encrypted RPD file before access to the document is granted.

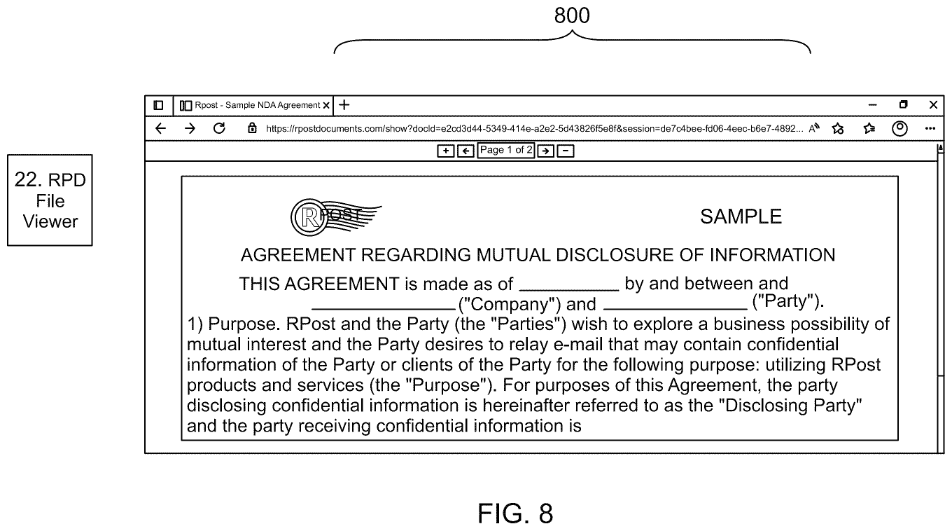

FIG. 8 shows an Opened RPD File Viewer Interface 800, namely a view of a document in a RPD file that has been opened in a web browser. The Opened RPD File Viewer Interface 800 corresponds to instances where access to the RPD file has been granted, for example when a successful authentication determination has been made. In the context of the RPD File Viewer, the Opened RPD File Viewer Interface 800 represents a contrast to the Encrypted RPD File Viewer Interface 700, in that it shows before and after access to the file has been granted.

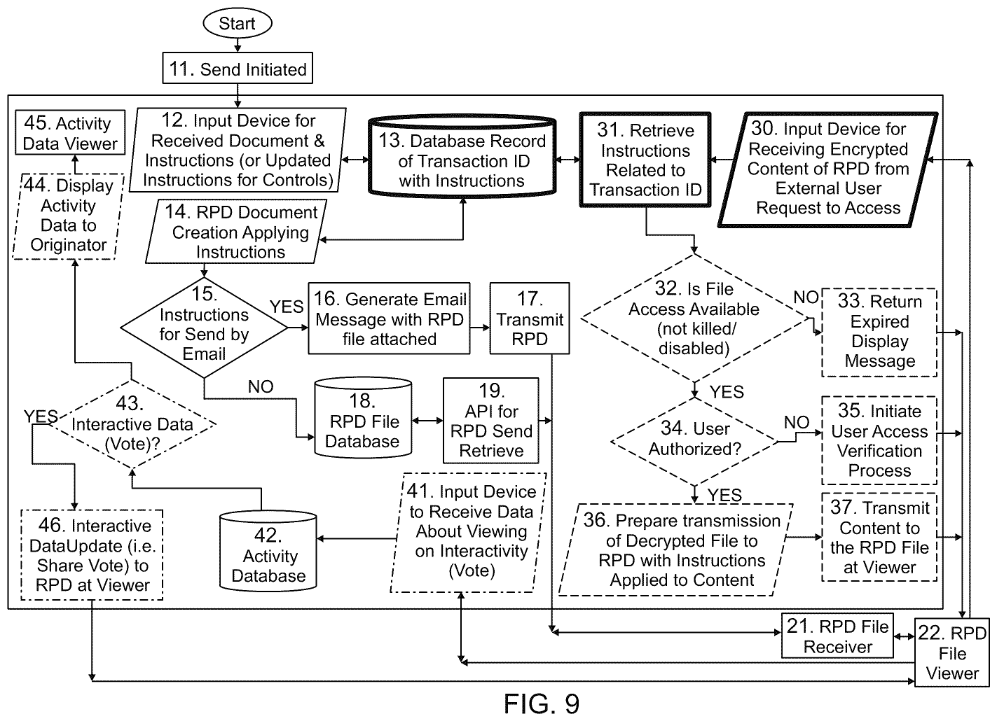

FIG. 9 is a modified flowchart of FIG. 2, wherein certain steps are grouped together to show their related function. The Transaction ID Database Group, denoted by thickened borders, comprises related steps 13, 30, and 31, which together form the process of taking an external user's request for access, accessing the database to retrieve a record containing the controls instructions associated with the Transaction ID to enable the execution of an authorization process. The Access and Authorization Group, denoted by dashed borders, comprises steps 32-37, where an analysis is conducted based on the controls instructions contained in the database record. The Activity Processing Group, denoted by dot-dash borders, comprises steps 41, 43, 44, and 46, which together perform the function of recording and displaying activity data. These functions may be performed by the Activity Unit 1040 of the Application Processing Unit 1000.

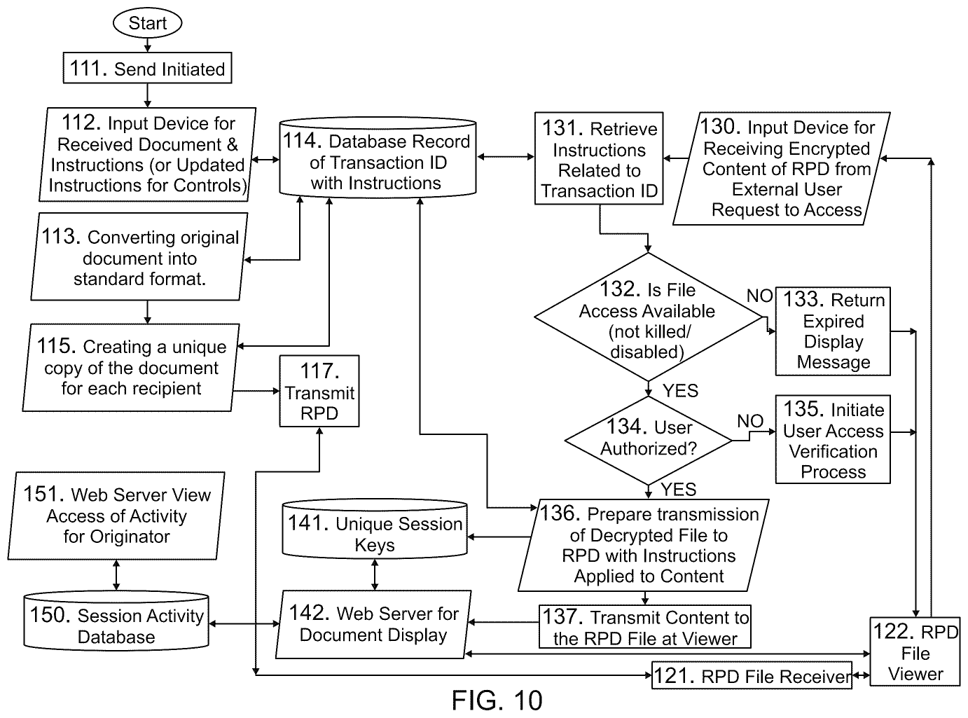

FIG. 10 is a flowchart of the functions of an RPD generation, control and transmission system according to an embodiment of the present invention. It describes the system that operates on a server programmed to receive files from an Originator, receive instructions on what content controls, security, or in-document interactivity to apply to the file, programmatically transform the original file into an RPD file, and make a new RPD file, wherein the RPD file may be retrieved from the server or transmitted from the server to a recipient.

In step 111, the sending of a file is initiated. The send can be initiated, for example, using the system's web sender interface, where a document is uploaded and controls instructions are added associated with the document. In another embodiment, the documents may be submitted via API along with data file with controls instructions. In another embodiment, documents may be submitted via API and a pre-set controls instructions would apply. In yet another embodiment, documents may be submitted via SMTP email routing, or other methods, such as a sender sending an email with attachments, and that email routes outbound through a data leak prevention system or server. The server identifies that there are attachments, and separates those attachments from the email, and transforms those attachments into RPD files by submitting them via API to a creation server. The API returns the transformed files, which are then re-attached to the email, and the email continues its routing to the recipient with the newly transformed attachments from original formats to RPD files. The party sending the file may be referred to as the Originator. The control instructions to be applied to the file may be specified by the Originator through the Document Receiving Unit Interface 300.

In step 112, the Document Receiving Unit 1010 receives the document and any instructions corresponding to that document. As an alternative to controls instructions, instead there may be an indication to use pre-set controls. For instance, if no control instruction file is included, the system may be configured to apply the most recently used control instructions as a default. In addition to the original instructions, the system may additionally be configured to update the instructions, such that they differ from the original instructions. These instructions may be entered in the Updated Instructions Input Interface 400.

In step 113, the document is converted into a standard format.

In step 114, a database record is created, wherein the database record records (i) the various parameters controlling the Originator's selected features and restrictions, as specified by the Originator in the Document Receiving Unit Interface 300, that will control access to the document and the features it will display, (ii) the address of each intended recipient of the document, (iii) a unique identifier for the document, and (iv) a unique identifier for each recipient of the document.

In step 115, a unique copy of the document is created for each recipient of the document. This step may encompass one or more underlying/related items, including: (i) Creating an .HTML document including scripts to control the functions of the RPD and its user interface, (ii) including in the .HTML document the received original document in its standard format and a unique identifier associated with the recipient, (iii) applying watermarks and displays to the document, as specified by the Originator in step 112, for instance via the Document Receiving Unit 1010 or the Document Receiving Unit Interface 300, (iv) encrypting the document using a randomly generated key that is unique to each instance of the document, (v) recording in the database the encryption key associated with the recipient, (vi) encoding the encrypted file in an HTML compatible format, (vii) embedding a copy of the encrypted file in the .HTML document, and (viii) if the document settings require authentication, creating a verification code unique to each recipient and recording this in the database record associated with the recipient.

In step 117, a copy of RPD file that displays as an .HTML document is transmitted to the intended RPD file receiver, and is received by RPD file receiver in step 121. The RPD file receiver may have the RPD document displayed on the Email Attachment Display Interface 600, as shown in FIG. 6. If the document requires authentication, a copy of the verification code may separately be transmitted to the recipient.

In step 122, the RPD file, namely the .HTML document with its contents and functions as prescribed above, is opened in the recipient's browser. When this occurs, according to step 130, the document transmits its unique identifier to the server. The “document” is the RPD file that is displayed at the recipient as an .html file. Then, in step 131, the server retrieves the records associated with this instance of the original document. During this process, the RPD File Viewer may display the Encrypted RPD File Viewer Interface 700, as shown in FIG. 7.

In step 132, the server determines whether or not the original document is currently available. If the original document is not available, for example if the Originator has expired the document, disabled it, killed it, or it is timed out, according to step 133, the server transmits an instruction to the document to display a message in the document (displaying in the HTML view of the document in the browser at the recipient) to the recipient indicating the document is not available. Alternatively, if file access is determined to be available, the system proceeds to step 134, where the server attempts to determine the geographical location of the IP address of the document's transmission. If it is determined that the location violates any geographical restrictions governing the document, according to step 133, the server transmits an instruction to the document to display a message to the reader indicating that the document is not available.

In step 135, the system initiates an access verification process, which begins with the server determining what form of authentication may be required for the document. If the documents require authentication, the server transmits a signal to the document, causing the document to prompt the recipient to enter the recipient's email address and verification code, which are then then transmitted to the server. Subsequently, the server determines whether the recipient's verification code is valid, and whether the user is currently permitted to read the document. For example, this analysis may consider whether or not the email address associated with the reader is within a domain that has been restricted by the Originator, which could be specified through the Content Protections Module 340 of the Document Receiving Unit Interface 400.

If the recipient is authenticated and reading would not violate the access restraints requested by the Originator, the system proceeds to step 136, where the server generates a unique session key, records the unique session key in a database, and transmits the unique session key to the document.

In step 137, upon receiving a session key, the document uploads to the server: (i) the session key, and (ii) the encrypted file content embedded in the document.

In step 142, upon receiving the encrypted file and the session key, the server uses the unique encryption key associated with the document to decrypt the file, and stores the plaintext version of the file in temporary storage identified by the session key. Upon receipt of an acknowledgment from the server that the upload has been successful, the document redirects the recipient's browser to a web page server, including the session key as a parameter. At the web server, the server retrieves the stored plaintext file from memory. To retain control of the document, the server does not download a copy of the plaintext file. Instead, each page of the plaintext file (i.e. a decrypted version of the original document) is separately converted to an image file and transmitted to the document such that it may be displayed on the Opened RPD File Viewer Interface 800. Each page is presented as an image to the recipient on the web page. A new page image is transmitted for display as the recipient pages through the document. The server records the time and length of the session in a Session Activity Database as a database record associated with the document and the recipient. The server deletes the temporarily stored decrypted file when the recipient ends the session, for example by closing the web page.

In step 151, the document activity and interactivity may be displayed to the Originator on the Activity Data Display Interface 500 or other report, thereby providing a web view of the Session Activity Database 150 via webserver access.

FIG. 11 is a flowchart of the system's authentication procedure when an RPD HTML document is attempted to be opened in the recipient's browser:

In step 201, the RPD HTML document displays an authorization request, and in step 202, sends the document ID and address, and verifies the cookie ID.

In step 203, the system determines whether the document exists by referencing a Document Database to determine whether the Document Database contains a record of the document ID. If the Document Database does not contain a record of the document ID, the process concludes at step 206, where the system denies authorization and displays a corresponding message inside the HTML document.

If the Document Database does contain a record of the document ID, in step 204 the control settings of the document are loaded from the Document Database, and the process proceeds to step 205, where the system determines whether the document is expired or not permitted to display/launch. If the document is expired or not permitted to display/launch, the process concludes at step 206, where the system denies authorization and displays a corresponding message inside the HTML document.

If the document is permitted to display/launch and it is not expired, in step 207, the system determines whether access to the document has been banned for that user, for example on the basis of the IP address, geolocation, or other pertinent control parameter.

If access has been banned, the process concludes at step 206, where the system denies authorization and displays a corresponding message inside the HTML document.

If access has not been banned, the process proceeds to step 208, where the system verifies the access security level. There are three tiers of Security Levels, namely Level 1 Security 1531, Level 2 Security 1532, and Level 3 Security 1533, as explained further regarding FIGS. 15-17.

If it is Level 1 Security, the process concludes at step 209, where the system returns the authentication code to the server, indicating that it is permissible to display/launch the document, thereby granting access to the reader.

If it is Level 2 Security, the process proceeds to step 210, where the system verifies whether the reader is a new reader. If the reader is a new reader, the process proceeds to step 211, wherein the Record Reader records the reader with an authentication process, and then in step 213, requests access to display/launch the document.

Alternatively, if the reader is not a new reader, the process proceeds to step 215, where the system determines whether the reader is banned. If access has been banned, the process concludes at step 214, where the system denies authorization and displays a corresponding message inside the HTML document. If the reader is not banned, the process proceeds to step 216, where the system verifies the code.

If the verification code is invalid, the process concludes at step 213, where the system requests access to display/launch the document. If the verification code is valid, the process proceeds to step 217, where the system verifies whether a maximum reads limit has been exceeded, if applicable.

If a maximum reads limit has been exceeded, the process concludes at step 214, where the system denies authorization and displays a corresponding message inside the HTML document.

If no maximum reads limit has been exceeded, the process concludes at step 209 where the system returns the authentication code to the server, indicating that it is permissible to display/launch the document, thereby granting access to the reader.

If it is Level 3 Security, the process proceeds to step 212, where the system verifies whether the reader is a new reader. If the reader is a new reader, the process concludes at step 214, where the system denies authorization and displays a corresponding message inside the HTML document.

Alternatively, if the reader is not a new reader, the process proceeds to step 215, where the system determines whether the reader is banned. If access has been banned, the process concludes at step 214, where the system denies authorization and displays a corresponding message inside the HTML document.

If the reader is not banned, the process proceeds to step 216, where the system verifies the code and cookies.

If the verification code is invalid, the process concludes at step 213, where the system requests access to display/launch the document.

If the verification code is valid, the process proceeds to step 217, where the system verifies whether a maximum reads limit has been exceeded, if applicable.

If a maximum reads limit has been exceeded, the process concludes at step 214, where the system denies authorization and displays a corresponding message inside the HTML document.

If no maximum reads limit has been exceeded, the process concludes at step 209 where the system returns the authentication code to the server, indicating that it is permissible to display/launch the document, thereby granting access to the reader.

The following code segment illustrates the part of the coding for one embodiment of the present disclosure, which can be read together with FIG. 11. The code snip is a part of the server-side code that authenticates a RPD .HTML file with the server when the RPD .HTML file connects with the server at the recipient.

```
response = (int)Responses.responses.denied;
    msg = ″This message is not yet available.″;
    evnt.explanation = (int)Responses.reasons.notLaunched;
    saveEvent(evnt);
    JObject rsp1 = new(
      new JProperty(″status″, response),
      new JProperty(″message″, msg)
    );
    return Ok(rsp1.ToString( ));
  }
  if (doc.ipRestricted || continentBanned(evnt.continentCode, doc.bannedCountries))
  {
    long remote = ConvertIPToLong(remoteIp);
    long startIp = ConvertIPToLong(doc.allowedIpStart);
    long endIp = ConvertIPToLong(doc.allowedIpEnd);
    if ((remote < startIp) || (remote > endIp))
    {
      response = (int)Responses.responses.denied;
      msg = ″Sorry. You are not authorized to read this message″;
      evnt.explanation = (int)Responses.reasons.badIp;
      saveEvent(evnt);
      JObject rsp1 = new(
        new JProperty(″status″, response),
        new JProperty(″message″, msg)
      );
      return Ok(rsp1.ToString( ));
    }
  }
  if (address != null)
  {
    for (int i = 0; i < doc.recipients.Count; i++)
    {
      if (doc.recipients[i].address == address) { reader = i; break; }
    }
  }
  if (cookie != null)
  {
    for (int i = 0; i < doc.recipients.Count; i++)
    {
      if (doc.recipients[i].cookieId == cookie)
      {
        address = doc.recipients[i].address;
        reader = i;
        break;
      }
    }
  }
  switch (doc.securityLevel)
  {
    case 1:
      //Security level 1 allows anyone to read but tracks openings by IP.
      response = (int)Responses.responses.allowed;
      session = evnt.event_id;
      if (reader == −1)
      {
        Sessions.Add(session, 0, doc.recipients[0].address, doc.steg);
      }
      else
      {
        Sessions.Add(session, 0, doc.recipients[reader].address, doc.steg);
      }
      if (cookie == doc.recipients[0].cookieId)
      {
        evnt.explanation = (int)Responses.reasons.reopen;
      }
      else
      {
        evnt.explanation = (int)Responses.reasons.opened;
        cookie = doc.recipients[0].cookieId;
      }
      break;
    case 2:
      if (reader > −1)
      {
        if ((doc.recipients[reader].verifyCode == verify) || (doc.recipients[reader].cookieId
== cookie))
        {
          if (doc.recipients[reader].banned)
          {
            response = (int)Responses.responses.denied;
            msg = ″Access denied″;
            evnt.explanation = (int)Responses.reasons.bannedRecipient;
          }
          else if ((doc.maxReads > 0) && (doc.recipients[reader].timesRead >
doc.maxReads))
          {
            response = (int)Responses.responses.denied;
            msg = ″Sorry! The reading limit for this document has been exceeded″;
            evnt.explanation = (int)Responses.reasons.maxReads;
          }
          else
          {
            if (cookie == doc.recipients[reader].cookieId)
            {
              evnt.explanation = (int)Responses.reasons.reopen;
            }
            else
            {
              evnt.explanation = (int)Responses.reasons.verified;
            }
            evnt.agent = address;
            response = (int)Responses.responses.allowed;
            session = evnt.event_id;
            if (reader == −1)
            {
              Sessions.Add(session, 0, doc.recipients[0].address, doc.steg);
            }
            else
            {
              Sessions.Add(session, reader, doc.recipients[reader].address, doc.steg);
            }
            cookie = doc.recipients[reader].cookieId;
            if (doc.recipients[reader].firstRead == DateTime.MinValue)
            {
              doc.recipients[reader].firstRead = DateTime.UtcNow;
            }
            doc.recipients[reader].timesRead += 1;
            rpdb.updateDoc(doc);
          }
        }
        else if (verify != doc.recipients[reader].verifyCode)
        {
          if (verify != null)
          {
            msg = ″Invalid verification code ″;
            evnt.explanation = (int)Responses.reasons.badVerify;
            response = (int)Responses.responses.verifyRequired;
          }
          else
          {
            msg = ″Please enter a verification code.″;
            evnt.explanation = (int)Responses.reasons.verificationRequested;
            response = (int)Responses.responses.verifyRequired;
          }
        }
      }
      else if (address != null)
      {
        if (doc.domains.Contains(domainOf(address),
StringComparison.OrdinalIgnoreCase))
        {
          response = (int)Responses.responses.denied;
          msg = ″Access denied″;
          evnt.explanation = (int)Responses.reasons.badDomain;
        }
        else
        {
          evnt.agent = address;
          Recipient newRec = new(address);
          newRec.source = doc.recipients[0].address;
          doc.recipients.Add(newRec);
          rpdb.updateCurrentDoc(doc);
          //if (doc.voting)
          //{
          // voting = true;
          // voted = newRec.vote;
          //}
          msg = ″You must enter a valid verification code.″;
          evnt.explanation = (int)Responses.reasons.verificationRequested;
          response = (int)Responses.responses.verifyRequired;
        }
      }
      else
      {
        response = (int)Responses.responses.verifyRequired;
        msg = ″Verfication Required″;
        evnt.explanation = (int)Responses.reasons.badVerify;
      }
      break;
    case 3:
      if (reader > −1)
      {
        if (verify == doc.recipients[reader].verifyCode || doc.recipients[reader].cookieId
== cookie)
        {
          if (doc.maxReads > 0)
          {
            if (doc.recipients[reader].timesRead >= doc.maxReads)
            {
              response = (int)Responses.responses.denied;
              msg = ″Reading limit exceeded″;
              evnt.explanation = (int)Responses.reasons.maxReads;
            }
          }
          else
          {
            if (doc.recipients[reader].firstRead == DateTime.MinValue)
            {
              doc.recipients[reader].firstRead = DateTime.UtcNow;
            }
            doc.recipients[reader].timesRead += 1;
            rpdb.updateDoc(doc);
            response = (int)Responses.responses.allowed;
            session = evnt.event_id;
            if (reader == −1)
            {
              Sessions.Add(session, 0, doc.recipients[0].address, doc.steg);
            }
            else
            {
              Sessions.Add(session, 0, doc.recipients[reader].address, doc.steg);
            }
            cookie = doc.recipients[0].cookieId;
            evnt.explanation = (int)Responses.reasons.verified;
            evnt.agent = address;
          }
        }
      }
      else if (address is not null)
      {
        response = (int)Responses.responses.denied;
        msg = ″Access denied″;
        evnt.explanation = (int)Responses.reasons.verificationRequested;
      }
      else
      {
        msg = ″You must enter a valid verification code.″;
        evnt.explanation = (int)Responses.reasons.verificationRequested;
        response = (int)Responses.responses.verifyRequired;
      }
      break;
  }
  evnt.response = response;
  saveEvent(evnt);
  JObject rsp = new(
    new JProperty(″status″, response),
    new JProperty(″message″, msg),
    new JProperty(″cookie″, cookie),
    new JProperty(″session″, session)
  );
  return Ok(rsp.ToString( ));
```

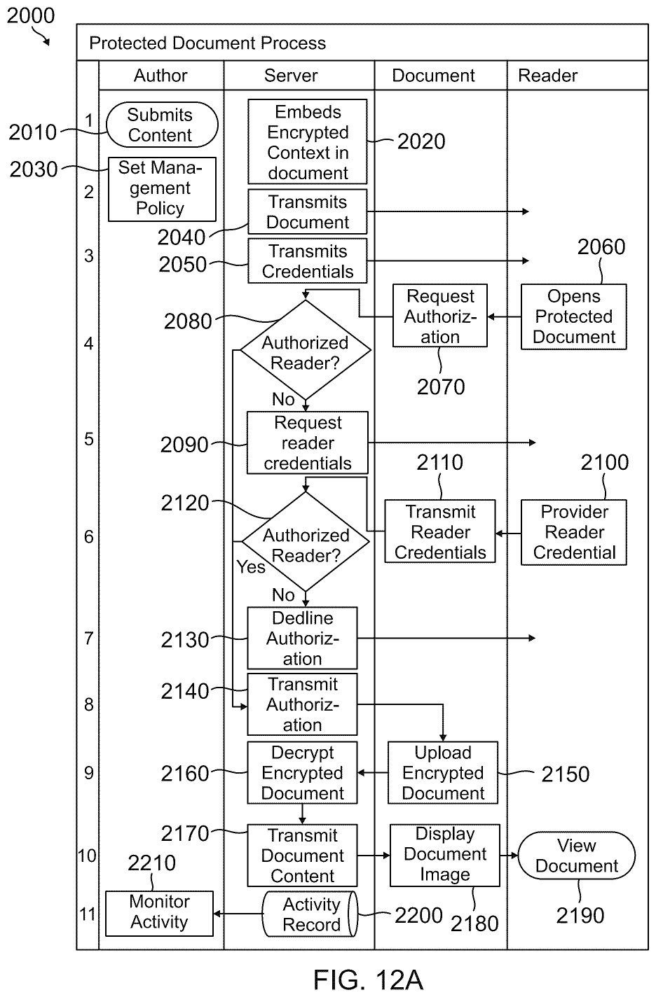

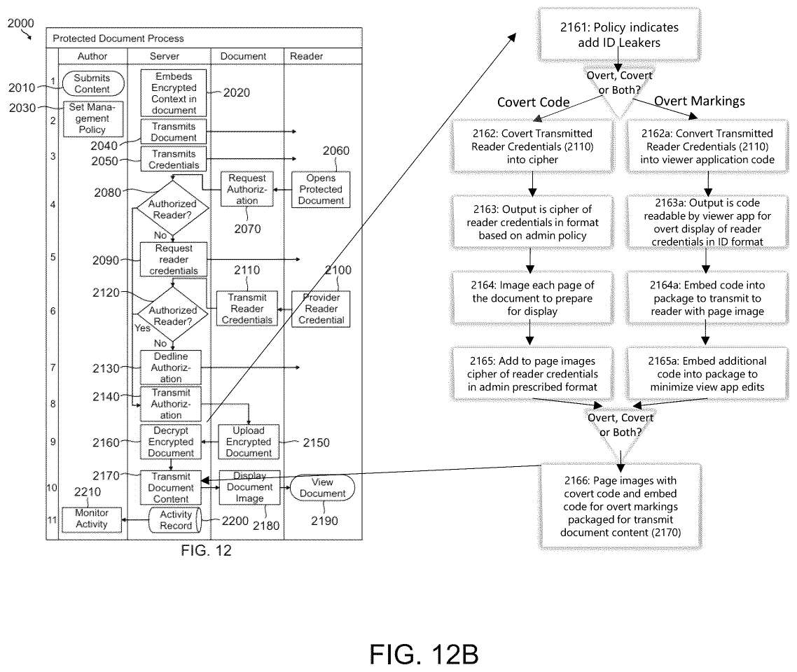

FIG. 12A is cross-functional flowchart detailing an RPD creation and access procedure according to an embodiment of the present invention. The flowchart describes the embodiment by showing the relationship between four elements: (i) the Author (also known as the document “Originator”), (ii) the system server, (iii) the Document (RPD as a .HTML File), and (iv) the recipient or Reader.

Phase 1: In step 2010, the Author submits the content to the server using an interface such as the Document Receiving Unit Interface 300 of FIG. 3, an API, SMTP email relay, or other interface. Subsequently, in step 2020 the server transfers the content into a uniform format and encrypts the content into the RPD .HTML document.

Phase 2: In step 2030 the Author sets the controls information and the management policy for access to the document. In step 2040, the management policy is transmitted as controls information to the server using the Document Receiving Unit Interface 300 shown in FIG. 3, an API, SMTP email relay, or other such means.

Phase 3: In step 2050, the packaged RPD .HTML document is transmitted to the reader, which may be displayed on the Email Attachment Display Interface 600, as shown in FIG. 6.

Phase 4: In step 2060, the reader opens the protected RPD .HTML document, and in step 2070, the document requests authorization verification at the server, during which the RPD File Viewer may view the Encrypted RPD File Viewer Interface 700, as shown in FIG. 7.

Phase 5: In step 2080, the server determines whether the reader is authorized. If the reader is authorized, the process skips to phase 10, whereas if the reader is not authorized, the process continues to phase 6.

Phase 6: In step 2090, the server requests reader credentials.

Phase 7: In step 2100, the reader provides their reader credentials, and in step 2110 the document transmits the reader credentials to the server. This phase is characterized as process to transmit credentials for access in order to verify that the reader has the appropriate access authorization.

Phase 8: In step 2120, the server again determines whether the reader is authorized. If the reader is authorized, the process skips to phase 10, whereas if the reader is not authorized, the process continues to phase 9.

Phase 9: In step 2130, the server sends a decline authorization display into the HTML document at the reader, thereby concluding the process for the unauthorized reader.

Phase 10: In step 2140, since the reader is authorized, the server transmits authorization to the document.

Phase 11: In step 2150, the encrypted document is uploaded from within the RPD .HTML File to the server, then in step 2160, the server decrypts the encrypted document.

Phase 12: In step 2170, the document content is transmitted from the server to the RPD .HTML File, which in step 2180 displays an image of each page as it is transmitted to the RPD .HTML File. Notably, all pages are images and each page it transmitted as one page image at a time, triggered by the page scroll inside the RPD .HTML File that sends a signal to the server as to which page to transmit and when. Subsequently, in step 2190, the reader views the protected document, for instance in an Opened RPD File Viewer Interface 800, as shown in FIG. 8.

Phase 13: In step 2200, the server monitors and stores the activity, and in step 2210, the activity is displayed to the Author in an interface, for example in the Activity Data Display Interface 500, as shown in FIG. 5.

FIG. 12B is cross-functional flowchart detailing an RPD creation and access procedure according to an embodiment of the present invention. The flowchart describes the embodiment by showing the relationship between four elements: (i) the Author (also known as the document “Originator”), (ii) the system server, (iii) the Document (RPD as a .HTML File), and (iv) the recipient or Reader. The modified flowchart of FIG. 12B adds further details for the Steganography functions occurring in the process flowchart of FIG. 12A between Phase 11 and Phase 12 as discussed above. This correlates to between Level 9 and 10 in the graphic of FIG. 12A.

In Phase 11 as modified in the embodiment shown in FIG. 12B, additional details for the Steganography (ID Leakers) feature are added. In step 2160 the document is decrypted to prepare for transmission as page images to the viewer application. In step 2161, the server determines whether the admin policy of the owner (originator, administrator for the originator, author) stipulates to include the Steganography features (ID Leakers) policy either with Covert Code, Overt Markings or Both.

If covert code steganography features were stipulated to be included, the process continues to step 2162, where the transmitted reader credentials (2110) received by the server are converted into the cipher at the server. In step 2163, the cipher of the credentials is outputted in the format based on the originators/authors admin policies. The format may include a variety of parameters including shape, density, text, or color, or any combination thereof, and these may represent the authorized authenticated reader identity information, including for instance, email address, text address, user ID, and device ID. In step 2164, the viewer selected pages of the document are prepared as an image of each document page. In step 2165, the cipher of the reader credentials is added to each page image in the format and pattern prescribed by the originator/author administrator.

Additionally or alternatively, if overt code steganography features were stipulated to be included, the process continues to step 2162a, where the transmitted reader credentials (2110) are converted into view code. The view code can be read by the viewer application to display an overlay of identity information floating and moving on top of the document page image in the viewer application. In step 2163a, the output is generated in the form of code readable by the document viewer application (e.g., web browser at viewer) for overt display of the reader credentials in Identity format. In step 2164a, this code is embedded into the data package to transmit to the reader with the page image. In step 2165a, additional code is embedded into the package to minimize the ability for the viewer to print the document or edit the overt identity markings in the viewer application.

In Phase 12 as modified in the embodiment shown in FIG. 12B, the process proceeds to step 2166, in which each page image properly prepared as aforementioned with covert code and the embed code for overt markings is packaged to transmit singularly as individual pages (document content) or groups of prepared page images (2170).

FIG. 13 illustrates an exemplary computer system 1300 which may be used with some embodiments of the present invention, which may be, for example, a server or a client computer system. Computer system 1300 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, etc. Computer system 1300 may be a combination of multiple forms. Computer system 1300 may include one or more computer systems 1300, be unitary or distributed, span multiple locations, span multiple systems, or reside in a cloud (which may include one or more cloud components in one or more networks).

In one embodiment, computer system 1300 may include one or more processors 1301, memory 1302, storage 1303, an input/output (I/O) interface 1304, a communication interface 1305, and a bus 1306. Although this disclosure describes and illustrates a particular computer system having a particular number of particular components in a particular arrangement, this disclosure contemplates other forms of computer systems having any suitable number of components in any suitable arrangement.

In one embodiment, processor 1301 includes hardware for executing instructions, such as those making up software. Herein, reference to software may encompass one or more applications, byte code, one or more computer programs, one or more executable module or API, one or more instructions, logic, machine code, one or more scripts, or source code, and or the like, where appropriate. As an example and not by way of limitation, to execute instructions, processor 1301 may retrieve the instructions from an internal register, an internal cache, memory 1302 or storage 1303; decode and execute them; and then write one or more results to an internal register, an internal cache, memory 1302, or storage 1303. In one embodiment, processor 1301 may include one or more internal caches for data, instructions, or addresses. Memory 1303 may be random access memory (RAM), static RAM, dynamic RAM or any other suitable memory. Storage 1305 may be a hard drive, a floppy disk drive, flash memory, an optical disk, magnetic tape, or any other form of storage device that can store data (including instructions for execution by a processor).

In one embodiment, storage 1303 may be mass storage for data or instructions which may include, but not limited to, a HDD, solid state drive, disk drive, flash memory, optical disc (such as a DVD, CD, Blu-ray, and the like), magneto optical disc, magnetic tape, or any other hardware device which stores computer readable media, data and/or combinations thereof. Storage 1303 maybe be internal or external to computer system 1300.

In one embodiment, input/output (I/O) interface 1304 includes hardware, software, or both for providing one or more interfaces for communication between computer system 1300 and one or more I/O devices. Computer system 1300 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, trackpad, biometric input device or sensor, or the like.

In still another embodiment, a communication interface 1305 includes hardware, software, or both providing one or more interfaces for communication between one or more computer systems or one or more networks. Communication interface 1305 may include a network interface controller (NIC) or a network adapter for communicating with an Ethernet or other wired-based network or a wireless NIC or wireless adapter for communications with a wireless network, such as a Wi-Fi network. In one embodiment, bus 1306 includes any hardware, software, or both, coupling components of a computer system 1300 to each other.

FIG. 14 is a graphical representation of an exemplary network 1400 that may be used to facilitate the various embodiments of the present invention. Server 1405 is operated by a services organization 1420, and typically includes at least one processor, input and output equipment or devices, memory, storage, and a communication interface. The server 1405 also operates under the control of specialized software programming commands that are designed to carry out the various processes described above. It should be understood that while the exemplary network 1400 is described in terms of a server 1405 operated by a services organization 1420, the server 1405 could be operated by a third party hired by the services organization or under the control of the services organization. The server 1405 could also be operated by a third party independent of the services organization, which then provides information and/or data to the services organization from which the services organization may provide services to a client 1425 of the services organization.

A data storage device 1410, which may be separate from the server 1405, but not necessarily, may be accessible to the server 1405, and may be used for storing date related to information and any other data related to operation of the various embodiments of the system and method described above. The data storage device 1410 may directly connected to the server 1405, or it may be accessible to the server 1405 through a network or the Internet 1415. The data storage device 1410 may also be a virtual storage device or memory located in the Cloud. These diagrams are describing some embodiments of the various embodiments of this disclosure, those skilled in the art will understand that there are other embodiments and more details within each of these embodiments not depicted in these diagrams.

Although the disclosed system has been described hereabove with reference to certain examples or embodiments, various additions, deletions, alterations and modifications may be made to those described examples and embodiments without departing from the intended spirit and scope of the disclosed heat exchange system. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any embodiment or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims. The disclosure is limited only by the scope of the appended claims.

FIGS. 15, 16, and 17 demonstrate some distinctions between the respective Level 1 Security, Level 2 Security, and Level 3 Security.

FIG. 15 shows a simplified schematic of the system functions according an embodiment of the present invention. A Document Owner 1510 engages in a Sender Experience 1520 in which an RPD document is created and either shared or downloaded. Subsequently, the Document Owner 1510 utilizes the Security Level Selection Module 1530 to select a desired level of security, each of which include differing features and restrictions.

Level 1 Security 1531 is referred to as the Track Views level. Tracking views provides the Document Owner 1510 insights into how many times and in what geographic locations the rights protected document has been opened and viewed. Level 1 Security 1531, imposes no requirements on the recipient other than to open and view documents. In a variation of Level 1 Security 1531, the Track Views & Restrict level, Document Owners 1510 can opt to restrict viewing to certain geographic locations or other internet locations such as only within their corporate network. Document Owners 1510 may additionally choose to protect the content by scheduling a precise document availability, and may apply additional advanced content protections to the document, including: (i) Proof of sending, (ii) Watermarking the document with visible marks, (iii) Timestamping the original document, (iv) Print restricting, (v) Permitting in-document message responses to the Originator, (vi) Generating authorized reader identity-marking to track a photo-capturing leaker, and (vii) Killing a document and all of its traces.

Level 2 Security 1532 is referred to as the Track Readers level. Tracking readers provides the Document Owner 1510 insights into how many times and in what geographic locations the document has been opened and viewed, with insights tagged to each reader. Readers are identified, associated with their authenticated email address. Insights are displayed to the Originator in a web-based activity log, displaying: (i) Notification of reading, (ii) Who read what and when, (iii) Tracked distribution, such as forwards, (iv) How many times the original document was read, (v) Time duration of each viewer's reading, and (vi) Geographic IP location of each reading.

The Track Readers level provides additional functionalities relating to Voting and In-Document Interactivity. This feature enables real-time in-document interactivity by allowing the document Originator to append notes to a document that are viewed by readers inside the document itself, and to carry out reader polls. Viewers can record their votes, comments or leave questions for the Originator. Votes may be recorded for each tracked reader and are tallied for the Originator in a web dashboard to easily track and view both the individual votes as well as the aggregate vote tally for each document. The Originator may further choose to permit each viewer to see how others with document access have voted, or the Originator may restrict the vote tally and vote details so that only the Originator has view of the vote results. The vote tally is updated in real time in the form of “Likes” and “Dislikes”, as votes are added. These features may for instance be activated via the Real-Time Interactivity Module 320 in the Document Receiving Unit Interface 300.

Level 3 Security 1533 is referred to as the Restrict Readers level. Level 3 Security 1533 provides the original sender all the controls and insights of Track Readers: Level 2 Security 1532, plus additionally allows the Originator to restrict who can read the rights-protected document. Readers are tracked and restricted (or provided access) via two-factor authentication to assure the reader associated with their email address is in fact who the Originator has authorized to access the rights protected document. Additionally, Level 3 Security 1533 provides an extra layer of protection by allowing the document Originator to: (i) Restrict viewing of the document to a registered viewer, and (ii) Restrict forwarding (distribution) of the document by a viewer.

The Document Owner 1510 may additionally utilize the Feature Selection Module 1540 to specify features and restrictions on the document. The Feature Selection Module 1540 may be the Document Receiving Unit Interface 300 of FIG. 3, which comprises an Access Controls Module 310, a Real-Time Interactivity Module 320, a Location Protections Module 330, and a Content Protections Module 340. The document is ultimately transmitted to the Document Reader 1550 with all the selected features applied.

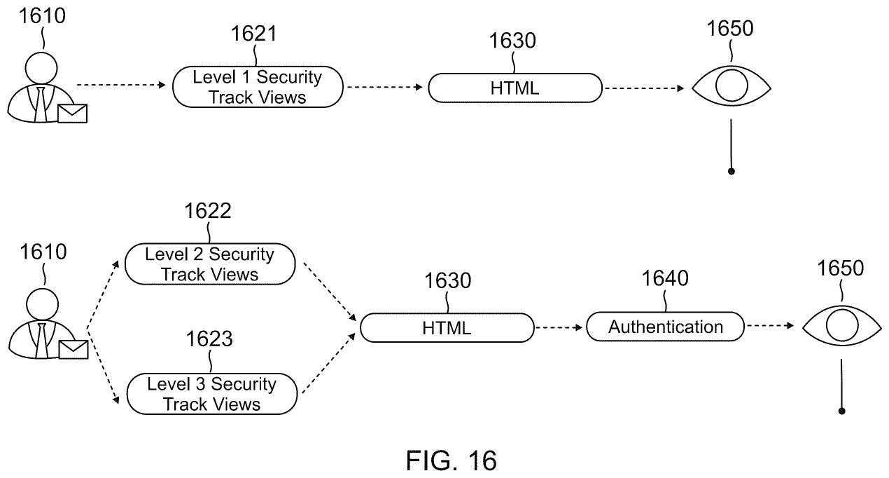

FIG. 16 is a simplified flowchart outlining the RPD transmittal and authentication process according to an embodiment of the present invention. In this process, a RPD document is transmitted from a Document Owner 1610 to a Document Reader 1650. For a document with Level 1 Security 1621, the document is transmitted directly to the Document Reader 1650 as an HTML Document 1630, as no authentication is required since anonymous viewing is permissible. In contrast, for documents with Level 2 Security 1622 or Level 3 Security 1623, an Authentication 1640 is required before a Document Reader 1650 may access it.

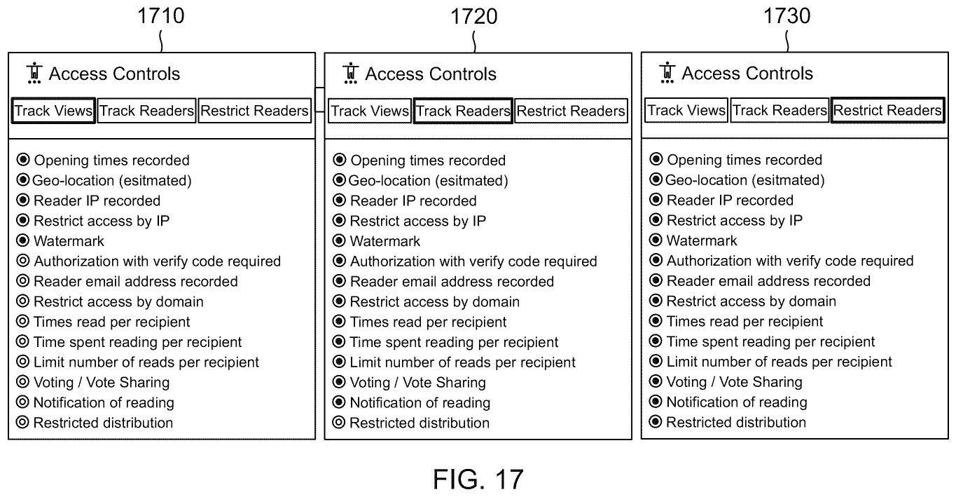

FIG. 17 shows a comparison of access control features for the respective security levels 1531/1621, 1532/1622, 1533/1623. The Level 1 Security Access Control Menu 1710 lists the features associated with Level 1 Security 1531/1621. The Level 2 Security Access Control Menu 1720 lists the features associated with Level 2 Security 1532/1622. The Level 3 Security Access Control Menu 1730 lists the features associated with Level 3 Security 1533/1623. This includes all features available in the Level 2 Security Access Control Menu 1720, but also includes an additional option to activate “Restricted Distribution”.

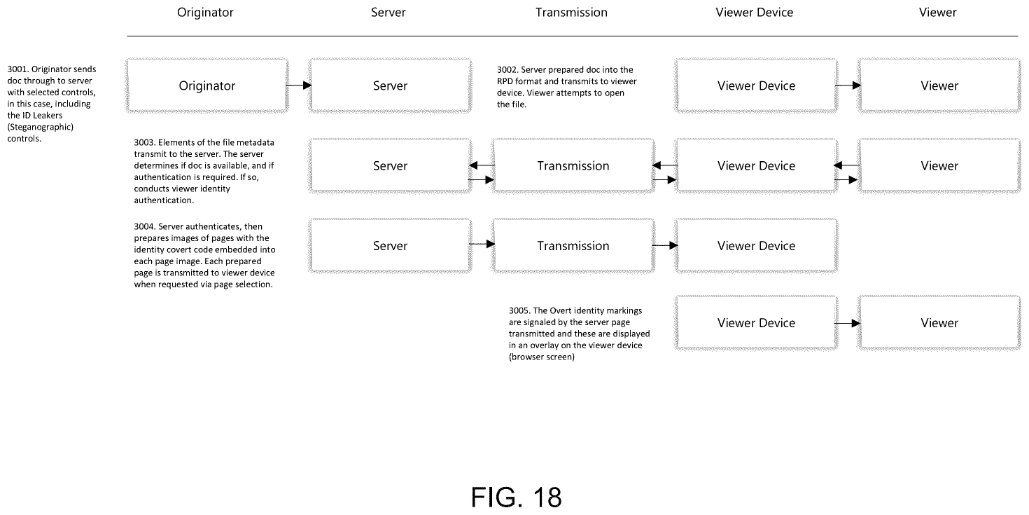

FIG. 18 shows the process of an originator sending a document that has the Identify Leakers steganographic feature enabled. The schematic flowchart in FIG. 18 further shows the processing of the document and the experience at the viewer's end. In step 3001, the originator sends the document to the server with selected controls, which in the present embodiment includes the Identify (ID) Leakers steganographic controls. In step 3002, the server prepares the document by converting it into the RPD format and transmits the document to a viewer device, where a Viewer attempts to open the file. In step 3003, elements of the file metadata are transmitted from the file back to the server. Based on this transmitted file metadata, the server determines whether the document is available, and whether authentication is required. If authentication is required, the server initiates a viewer identity authentication process. In step 3004, the server authenticates the identity of the viewer, prepares images of pages to be viewed, and re-transmits them to the viewer with the identity covert code embedded onto each page image. Each prepared page is transmitted to the viewer device when requested via the viewer page selection. In step 3005, the Overt identity markings are prepared by the server, and these are displayed in an overlay on each transmitted page on the viewer device by the viewer application (e.g., web browser application display).

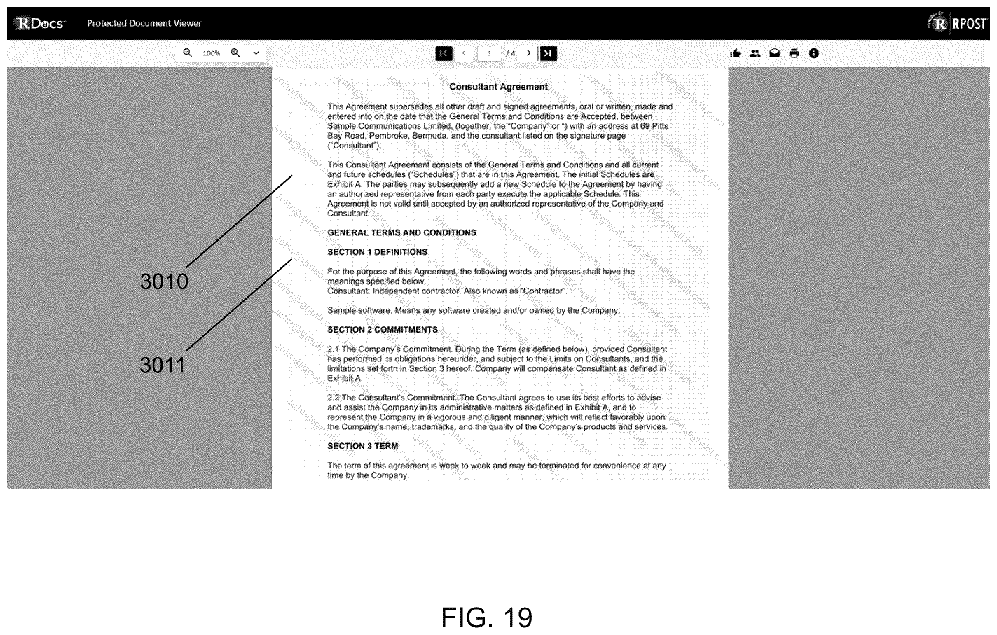

FIG. 19 shows an exemplary embodiment of the Identify Leakers on a document, where the Identify Leakers include both high density covert code markings 3010 and floating text overt markings 3011. The Covert Code markings 3010 are embedded on each page unique to the authenticated viewer and each page, and may be displayed as a high density cluster of markings forming a pattern on the page of the document. According to the embodiment shown in FIG. 19, the covert code markings 3010 may form an array of fragmented horizontal lines. The Identity Leakers may further comprise Overt Identity Markings 3011, which may visually float on device via the viewer application (e.g., web browser) with movement. The overt identity markings 3011 may for instance be unique to the authenticated authorized viewer, for example displaying the text such as the viewer's email address. According to an embodiment, the overt identity markings 3011 may be displayed diagonally and in a faint shade so as not to affect legibility of the document text. Alternatively, the overt identity markings 3011 may be vertical or horizontal, and may be displayed with any suitable color or shade.

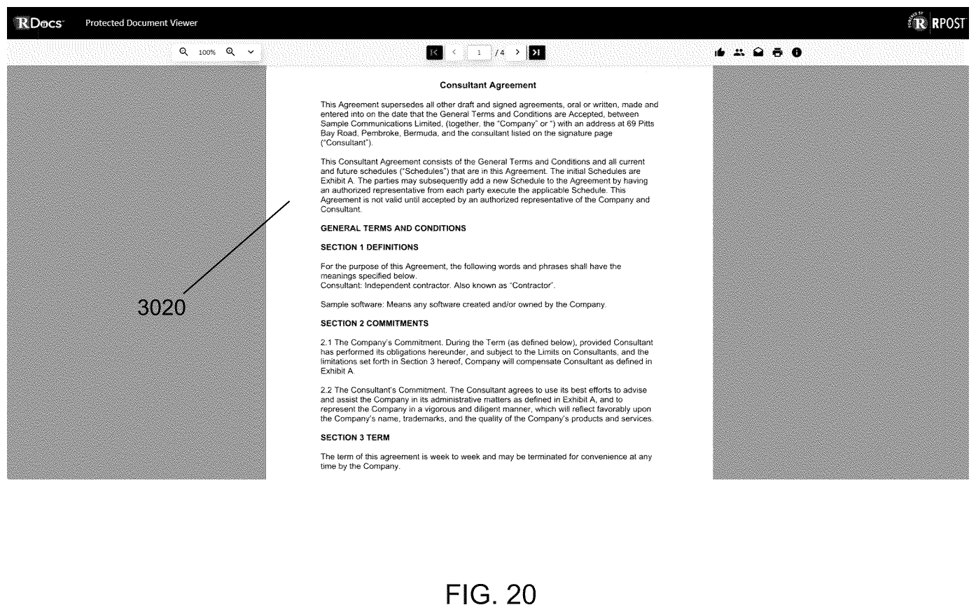

FIG. 20 shows an exemplary embodiment of Identify Leakers on a document, where the Identify Leakers include covert code markings 3020 in the form of different shapes. The Covert Code markings 3020 are embedded on each page, and are unique to each authenticated authorized viewer and authenticated viewed page. Covert code is created by a cipher at the server based on shape size and form, which is converted into covert code markings 3020. According to the embodiment in FIG. 20, the covert code markings 3020 may comprise a plurality of triangular shapes having varying geometric forms. These covert code markings 3020 may be disposed at non-uniform distances from one another, and in some cases may overlap with adjacent covert code markings 3020. The skilled artisan would appreciate that any number of shapes, symbols, or characters may be used to form a uniform or non-uniform pattern of covert code markings 3020.

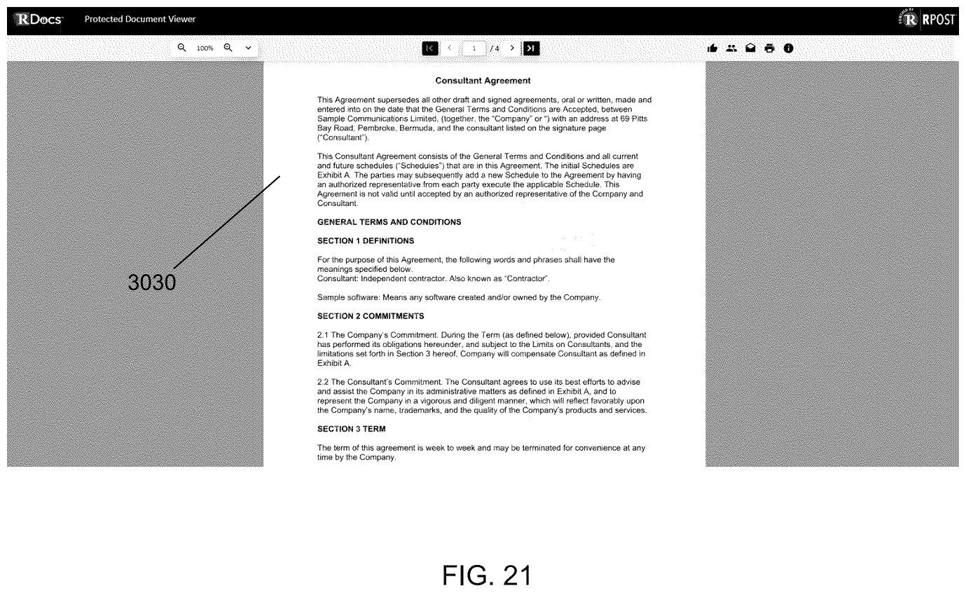

FIG. 21 shows an exemplary embodiment of Identify Leakers on a document, where the Identify Leakers include covert code markings 3030 in the form of different shapes. The Covert Code markings 3030 are embedded on each page at the server, and each set of covert code markings 3030 are unique to the authenticated authorized viewer and each page. The covert code markings 3030 can comprise a variety of shapes depending on the cipher and settings applied by the document owner or administrator. The covert code transforms the identity information into various shape sizes and forms, which are converted into covert code markings 3030 in the document. This transformation is intended to mask from the authorized viewer or those who have received the leaked information, which parts of the covert markings 3030 contain the details needed by the system to decipher who the original leaker was. According to the embodiment in FIG. 21, the covert code markings 3030 may comprise a plurality of star shapes having varying sizes and orientations. These covert code markings 3030 may be disposed at non-uniform distances from one another, and in some cases may overlap with adjacent covert code markings 3030. The skilled artisan would appreciate that any number of shapes, symbols, or characters may be used to form a uniform or non-uniform pattern of covert code markings 3030. Based on the unique pattern of covert code markings 3030, it is possible to determine the identity of the incident authenticated authorized viewer.

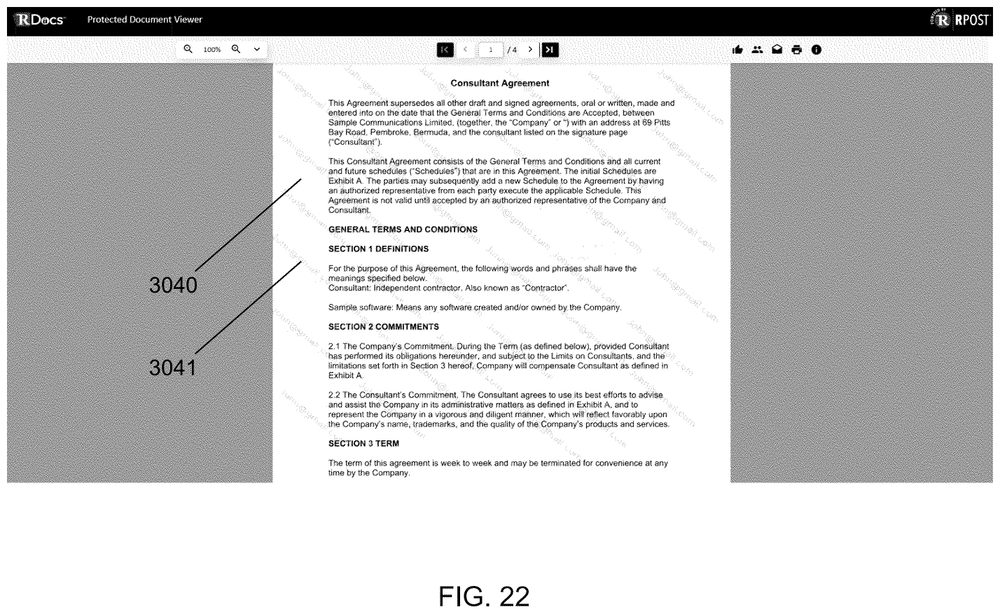

FIG. 22 shows an exemplary embodiment of Identify Leakers on a document, where the Identify Leakers include covert code markings 3040 in the form of different shapes and overt markings 3041 in the form of floating text. The Covert Code markings 3040 are embedded on the page and are unique to the viewer and page. The Overt Identity Markings 3041 are floating on the device in the view of the viewer application (e.g., web browser) with movement, size, and colors depending on the settings applied by the originator or their administrator. The overt identity markings 3041 are unique to each authenticated authorized viewer.

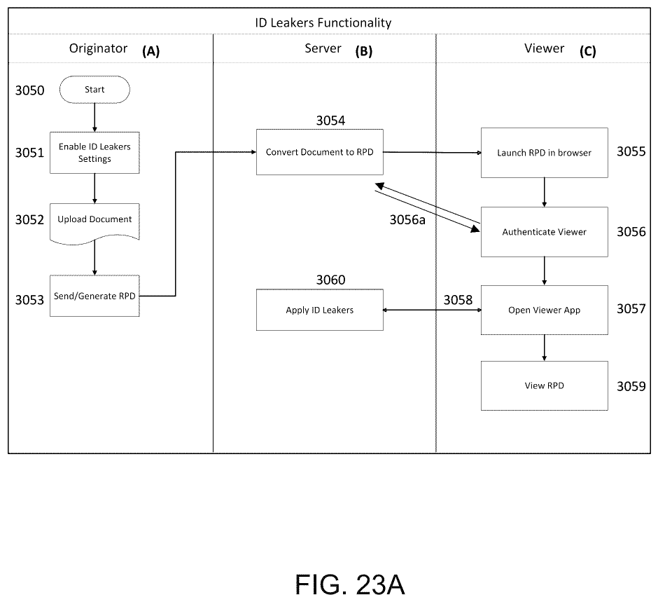

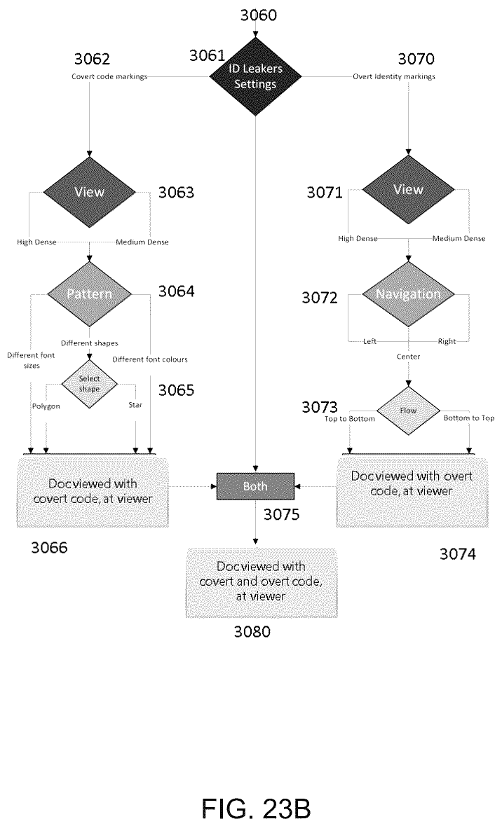

FIG. 23A shows a data flow chart for the Identify Leakers functionality for applying configurable shapes and floating text to a document. In this embodiment, the schematic flowchart includes functions divided into three positions, namely the originator (A), the server (B), and the viewer (C). The process starts with step 3050 at the originator (A), where an encrypted package is created for transmission. The encrypted package may comprise the original document or documents having controls features, which may be selected or pre-selected. In step 3051, ID Leakers control settings may be enabled, which may include parameters such as the speed, shape, color, direction of the markings that would display at the viewer. These are shown in FIG. 23B, in steps 3063-3065 for the covert markings 3062 and steps 3071-3073 for the overt markings 3070. In step 3052, the document(s) are uploaded or otherwise transmitted into the application at the sender. Alternatively, the server may be configured with an intake to receive the documents. In step 3053, the sender or sender system automatically transmits the document(s) tagged with the specific features into the server (B) intake, which is configured to receive the documents. In step 3054 at the server (B), the sent document is pre-processed into a standard document format to speed up future imaging processing. Additionally, the original sent control instructions and the transaction document ID generated at the time of pre-processing are encapsulated within the encrypted content to be transmitted from the server (B) to the Viewer (C).

After the click to open the RPD at the viewer (C), in step 3055, the documents now in the RPD format launches in the browser or viewer application at the viewer, but does not display the document content, which remains encrypted at this stage. In step 3056, depending on the original sender controls settings, the viewer is authenticated to an email ID, a device ID, an SMS/Text number, an application ID, other application logon access ID, or other type of authenticated identity information. In step 3056a, after successful authentication of the viewer identity and/or permissions to view the document, access credentials are returned by the server as valid. In step 3057, the viewer browser or other viewer application opens. In parallel, in step 3058, the RPD file elements are transmitted back to the server (B).

At the server (B), the RPD file is further prepared for display at the system server. The Document ID and some metadata is passed from viewer authentication process into the system server. This metadata may include recipient/reader email addresses, depending on the selected control instructions. If the document is killed based on originator rules, is expired, the max authorized or remaining reads per reader are exceeded, no further units are available, or access is otherwise not authorized by location or other reasons, as determined from passed metadata and Doc ID lookup compared to controls in the database at the system, then system sends message to viewer to display message document not available.

If document is alive based on the originator rules or can be permitted to be viewed, then the system server determines if the document is required to limit viewers or track who is viewing.

In a preferred embodiment, the viewer restrictions may be enforced by authenticating the requesting viewer with a list of authorized viewers of the document, said list stored at the server. Otherwise, if no viewing restrictions are imposed but viewer tracking is required based on document controls at the server, then sends signal to the viewer to authenticate the requesting viewer, according to step 3056a. The viewer authentication can be effected through email authentication, SMS/text authentication, or other user device login, multi-factor authentication, one time passcode, or other authentication method. Once the requesting viewer is authenticated, the authenticated identity is passed to the server process to prepare the document for viewing. The authenticated identity may include identifying information such as email address, SMS number, digital ID, device login ID, etc.

If the document is alive based on the originator rules or can be permitted to be viewed by this authenticated viewer, then the system server sends a signal to the viewer to transmit the document back into the system server, according to step 3058. More specifically, an encrypted document package that contains the document and full metadata of controls information and document ID is transmitted.

At the server (B), upon receipt of the encrypted document package, the file is further prepared at the viewer (C) to transmit content to the viewer, according to step 3058. At the server (C), the encrypted document package received at the server is decrypted and the document is prepared based on the controls information, which may include preparation to at least include a subset of pages, creation of an image of each page, and application the ID Leakers function 3060 based on the ID Leakers settings 3061. Ultimately, the process proceeds to open the viewer in step 3057, so that a recipient may view the RPD in step 3059.

FIG. 23B shows a schematic flowchart for the application of the ID Leakers function 3060 according to a step of the flowchart shown in FIG. 23A. If the settings are for covert code markings, the authenticated identity is encoded, using a cipher or otherwise, to create a covert code related to the identity of the specific authorized viewer. In step 3066, the image of only the requested page is delivered to the viewer. The covert code is embedded on the image in multiple locations with different color schemes, like a dynamically generated watermark, and the specific color scheme and marking locations are uniquely associated with that authenticated authorized viewer and unique associated with that specific page. For the covert code, the density parameter may be selected in step 3063, the pattern parameter including font, shape, colors, and unique patterns may be selected in step 3064, and the shape parameters may be selected in step 3065. The other imaged pages prepared with the covert code markings or prepared pre-or-post-appending the covert code markings, may be held in memory at the server (C) until the viewer opts to view another page.

If the viewer opts to view a page that has not yet been put in image form, then that requested page and pages surrounding are imaged to speed up viewer experience while switching pages, after which that requested page is delivered to the viewer.

At the viewer in the viewing application (e.g., web browser), the overt identity markings 3070 display in a different pattern with movement across the screen based on settings and preferences. In step 3071, the parameters for visual aspects of the overt identity markings 3070 such as density may be selected, for instance high density, medium density, or low density. In step 3072, the parameters for the navigation aspects of the overt identity markings 3070 may be selected, for instance whether the overt identity markings 3070 should move left, right, or centrally. In step 3073, the parameters for the flow aspects of the overt identity markings 3070 may be selected, for instance whether the movement direction should be from top to bottom or from bottom to top.

At the viewer, the viewer application is instructed by the file transmitted from the server to not cache images, namely to not store them in the memory at viewer.

An expert skilled in the art would understand that this covert code markings 3062 can be displayed on the document alone at the viewer according to step 3066, or that the overt markings 3070 can be displayed on the document alone at the viewer, according to step 3074. If ID Leakers Settings include both covert code markings 3062 and overt identity markings 3070, these may be combined according to step 3075 and both be included on the document such that it can be viewed in the viewer browser at the viewer according to step 3080. Covert markings 3062 and Overt markings 3070 could include a variety of varying parameters, including different forms, density, movement speed, no movement, colors, shapes, sizes, etc. These could be adjustable by the originator or an administrator for the originator, as shown in steps 3063-3065 for the covert code markings 3062 and steps 3071-3073 for the overt code markings 3070.

An expert skilled in the art would understand that these capabilities are also available to be added to a document management or document storage system that would operate the process of adding the Covert and/or Overt markings to the document in a process between where the document is stored and displayed on in a viewing application for a viewer.

An expert skilled in the art would understand that these capabilities are also available to be added to a document workflow system or email security gateway transforming attachments en route to recipients with the invention. In this embodiment, the system would operate the process of adding the Covert and/or Overt markings to the document in a process between where the document is stored and displayed on in a viewing application for a viewer.

An expert skilled in the art would understand that these capabilities are also available to be added to a viewer of application data (e.g., a browser or other proprietary viewer or application data) where the identity of the viewer is based on their log-in access to the application or device, and the markings are displayed as an overlay on the browser or application viewer software dynamically generated and displayed.

In the abovementioned figures, the following provides more details:

FIG. 1, 1030 creation is further described at (A) below. 1042 Information control preparation unit is further described at (B) below. 1046 Controlled Information Transmit Unit is further described at (C) below.

FIG. 2, 30 receive entire content encrypted is further described at (A) below. 36 Prepare at the system server is further described at (B) below. 37 Transmit content to viewer is further described at (C) below.

FIG. 7, 3, the entire message content is received encrypted is further described at (A) below.

FIG. 9, 30 receive entire content encrypted is further described at (A) below. 36 preparing is further described at (B) below. 37 Transmit content at viewer is further described at (C) below.

FIG. 10, 130 receive entire content encrypted is further described at (A) below. 136 Prepare is further described at (B) below. 137 Transmit content at viewer is further described at (C) below.

FIG. 12A, 2150 entire document uploaded is further described at (A) below, 2170 transmit document content is further described at (B) below. 2180 displayed images is further described at (C) below.

(A) Pre-process to create the encrypted package to transmit
The original sent document pre-processed into a standard document format to speed future imaging processing plus the original sent control instructions and the transaction document ID generated at the time of pre-processing are encapsulated within the encrypted content received.

After the click to open the RPD at the viewer,

(B) Prepare at the system server
Document ID and some metadata (may include recipient/reader email address based on control instructions) is passed from viewer to system server
if document is (by originator rules) killed or expired, max authorized or remaining reads per reader, units available, or otherwise not authorized by location, etc. as determined from passed metadata and Doc ID lookup compared to controls in the database at the system, then system sends message to viewer to display message document not available.
if document is (by originator rules) alive or can be permitted to be viewed, then the system server sends signal to the viewer to transmit the document (encrypted document package that contains the document and full metadata of controls information and document ID) to the system server.

(C) Transmit content to viewer

At server upon receipt of the encrypted document package,
encrypted document package is decrypted
document is prepared based on the controls information, with preparation to at least include
for a subset of pages, creating an image of each page
delivering the image of the viewer requested page to view to the viewer (only that page)
holding the other imaged pages in memory until the viewer opts to view another page.
if the viewer opts to view a page that has not yet been put in image, then that requested page and pages surrounding are imaged
that requested page is delivered.

At viewer, instructed by server not to cache images (not store in memory at viewer).

### LISTING OF REFERENCE NUMERALS

Send Initiated 11
Input Device and Receive Documents & Instructions 12
Database Record of Transaction ID With Instructions 13
RPD Document Creation Applying Instructions 14
Instructions For Send by Email 15
Generate Email Message with RPD File Attached 16
Transmit RPD 17
RPD File Database 18
API For RPD Send Retrieve 19
RPD File Receiver 21
RPD File Viewer 22
Input Device for Receiving Encrypted Content of RPD From External User Request To Access 30
Retrieve Instructions Related to Transaction ID 31
Is File Available 32
Return Expired Display Message 33
User Authorized? 34
Initiate User Access Verification Process 35
Prepare Transmission for Decrypted File to RPD With Instructions Applied to Content 36
Transmit Content to The RPD File at Viewer 37
Input Device to Receive Data About Viewing on Interactivity 41
Activity Database 42
Interactive Data 43
Display Activity Data to Originator 44
Activity Data Viewer 45
Interactive Data Update to RPD At Viewer 46
Send Initiated 111
Input Device and Receive Documents & Instructions 112
Converting Original Document into Standard Format 113
Database Record of Transaction ID With Instructions 114
Creating A Unique Copy of The Document for Each Recipient 115
Transmit RPD 117
RPD File Receiver 121
RPD File Viewer 122
Input Device Receiving Unique Identifier, Encrypted Content of RPD From External User Request to Access 130
Retrieve Instructions Related to Transaction ID 131
Is File Access Available 132
Return Expired Display Message 133
User Authorized? 134
Initiate User Access Verification Process 135
Prepare Transmission of Decrypted File to RPD With Instructions Applied to Content 136
Transmit Content to The RPD File at Viewer 137
Unique Session Keys 141
Web Server For Document Display 142
Session Activity Database 150
Web Server View Access of Activity for Originator 151
Authorization Request 201
Document ID Address Verify Cookie ID 202
Document Exists 203
Load Document Control Settings 204
Expired/Not Launched? 205
Deny Authorization 206
Banned IP/Location 207
Security Level 208
Return Authorization Code 209
New Reader? 210
Record Reader 211
New Reader? 213
Deny Authorization 214
Reader Banned 215
Valid Verify Code/Cookie 216
Max Reads Exceeded 217
Document Receiving Unit Interface 300
Access Controls Module 310
Real-Time Interactivity Module 320
Location Protection Module 330
Content Protections Module 340
Updated Instructions Input Interface 400
Kill Selected Button 410
Status Column 420
Activity Data Display Interface 500
Activity Data Table 510
Activity Data Profile 520
Email Attachment Display Interface 600
Encrypted RPD File Viewer Interface 700
Opened RPD File Viewer Interface 800
Application Processing Unit 1000
Document Receiving Unit 1010
Processing Instructions Unit 1020
RPD File Creation & Send Unit 1030
Activity Unit 1040
Validating Access Request Unit 1042
Information Control Preparation Unit 1044
Controlled Information Transmit Unit 1046
Activity History Management Unit 1048
Interactive Content Processing Unit 1050
Input/Output Unit 1110
Input Unit 1110
Message Dialog Box Unit 1120
Display Unit 1130
Output Unit 1140
Central Processing Unit 1200
User Management Unit 1210
Database Unit 1220
Memory Unit 1230
Server 1240
Validation Unit 1250
Computer System 1300
Processor 1301
Memory 1302
Storage 1303
I/O Interface 1304
Communication Interface 1305
Bus 1306
Network 1400
Server 1405
Data Storage Device 1410
Internet/Network 1415
Provider 1420
Client 1425
Document Owner 1510
Sender Experience 1520
Security Level Selection Module 1530
Level 1 Security 1531
Level 2 Security 1532
Level 3 Security 1533
Feature Selection Module 1540
Document Reader 1550
Document Owner 1610
Level 1 Security 1621
Level 2 Security 1622
Level 3 Security 1623
HTML 1630
Authentication 1640
Document Reader 1650
Level 1 Security Access Control Menu 1710
Level 2 Security Access Control Menu 1720
Level 3 Security Access Control Menu 1730
Protected Document Process 2000
Submit Content 2010
Set Management Policy 2020
Embeds Encrypted Content in Document 2030
Transmits Document 2040
Transmits Credentials 2050
Opens Protect Document 2060
Request Authorization 2070
Authorized Reader? 2080
Request Reader Credentials 2090
Provider Reader Credential 2100
Transmit Reader Credentials 2110
Authorized Reader? 2120
Decline Authorization 2130
Transmit Authorization 2140
Upload Encrypted Document 2150
Decrypt Encrypted Document 2160
Policy Indicates Add ID Leakers 2161
Convert Transmitted Reader Credentials Into Cipher 2162
Convert Transmitted Reader Credentials into viewer application code 2162a
Output is cipher of reader credentials in format based on admin policy 2163
Output is code readable by viewer app for overt display of reader credentials in ID format 2163a

Image each page of the document to prepare for display 2164
Embed code into package to transmit to reader with page image 2164a
Add to page images cipher of reader credentials in admin prescribed format 2165
Embed additional code into package to minimize view app edits 2165a
Page images with covert code and embed code for overt markings packaged for transmit document content 2166
Transmit Document Content 2170
Display Document Image 2180
View Document 2190
Activity Record 2200
Monitor Activity 2210
Covert Code Markings 3010
Overt Code Markings 3011
Covert Code Markings 3020
Covert Code Markings 3030
Covert Code Markings 3040
Overt Code Markings 3041
Start 3050
Enable ID Leakers Settings 3051
Upload Document 3052
Send/Generate RPD 3053
Convert Document to RPD 3054
Launch RPD in browser 3055
Authenticate Viewer 3056
Authenticate Viewer 3056a
Open Viewer App 3057
RPD File Element Transmission 3058
View RPD 3059
Apply ID Leakers 3060
ID Leakers Settings 3061
Covert Code Markings 3062
View Settings 3063
Pattern Settings 3064
Shape Settings 3065
Doc viewed with covert code at viewer 3066
Overt Code Markings 3070
View Settings 3071
Navigation Settings 3072
Flow Settings 3073
Doc viewed with overt code at viewer 3074
Both 3075
Doc viewed with covert and overt code at viewer 3080

1. An electronic document transformation and sharing system allowing a document originator control over an electronic document shared with at least one recipient, said system comprising:
an input device configured to receive at least one original electronic document;
a web server;
a database on said web server, configured to store an identifier for each document received by the input device;
a data transmission subsystem transmitting to at least one recipient an information link identifying the document;
a viewer configured to display images in standard formats;
a verification subsystem at the server for executing an electronic transformation document viewer identity authentication process, said verification subsystem configured to:
receive from the recipient a recorded string of identity data associated with the authenticated viewer at the database on said web server; and
generate authentication information representing the string of identity data associated with the authenticated viewer, and
a document transmission subsystem, said document transmission subsystem configured to:
receive requests to view identified documents;
respond to requests to view a document by singularly returning an image of each requested page of the original document, and
return the identity authentication information displayed on each image of each page as it is viewed at the viewer.

2. The system of claim 1, wherein the authentication information is embedded within each image of each page of the document before it is viewed at the viewer, such that the authentication information is part of the image when it is viewed at the viewer.

3. The system of claim 2, wherein the authentication information is included in the image as covert markings represented by at least one of: a shape, symbol, text, or color.

4. The system of claim 2, wherein the authentication information is overlaid as floating overt markings on top of the image of each page as it is viewed at the viewer.

5. An electronic information sharing system allowing an information controller control over an electronic information or document shared with at least one recipient, said system comprising:
an electronic transformation information viewer configured to generate authentication information representing a string of identity data associated with the authenticated viewer, said electronic transformation information viewer configured to display images in standard formats;
a web server;
an input device configured to receive a representation of an authenticated information viewer identity;
a database on said web server, storing an identifier for each authorized viewer;
a transmission subsystem configured to:
receive inputs from file requests to view identified file information;
respond to file requests to view an information by singularly returning (i) an image of each requested page of a document, or (ii) a display of data for each request to view the information, and
return to the electronic transformation information viewer singularly an image of information with the identity authentication information displayed on each image of each page as it is viewed at the viewer.

6. The system of claim 5, wherein the authentication information is embedded within each image of each page of the document before it is viewed at the viewer, such that the authentication information is part of the image when it is viewed at the viewer.

7. The system of claim 6, wherein the authentication information is included in the image as covert markings represented by at least one of a shape, symbol, text, or color.

8. The system of claim 5, wherein the authentication information is overlaid as floating overt markings on top of the image of each information page as it is viewed at the viewer.

9. An apparatus for receiving identity authentication information related to a viewer of an electronic file and transforming the viewer experience of the electronic file using received identity authentication information, the apparatus comprising:
an input device configured to receive:
identity authentication information associated with a prospective authorized authenticated viewer of an electronic file, and
the electronic file designated for viewing by the prospective authorized authenticated viewer,
a server with a database for storing the identity authentication information for each prospective authorized authenticated viewer; and
a processor configured to perform at least the functions of:
combining the identity authentication information representative of the prospective viewer with the electronic file, and
displaying the electronic file with the identity authentication information representative of the prospective authorized authenticated viewer to the authenticated viewer.

10. The apparatus of claim 9, wherein
the identity authentication information associated with the prospective authenticated viewer is converted into a cipher, and
a representation of the cipher that is unique to the prospective authenticated viewer is displayed to the authenticated viewer in the form of covert markings that are visible but coded.

11. The apparatus of claim 9, where the identity authentication information is converted into a visible authenticated viewer identity string unique to the prospective authenticated viewer.

12. The apparatus of claim 10, wherein
the identity authentication information associated with the prospective authenticated viewer is converted into visible overt markings comprising an authenticated viewer identity string unique to the prospective authenticated viewer.

13. The apparatus of claim 10, wherein the covert markings are represented by at least one of letters, numbers, and symbols having varying sizes, densities, and colors.

14. The apparatus of claim 12, wherein the overt markings are represented by at least one of letters, numbers, and symbols having varying sizes, densities, and colors, wherein the overt markings dynamically float over the electronic file displayed in the viewer.

15. A system configured to receive identity authentication information related to a viewer of an electronic file and transform the viewer experience of the electronic file using the received identity authentication information, the system comprising:
an input device configured to:
receive identity authentication information associated with a prospective authorized authenticated viewer of an electronic file, and
receive the electronic file designated for viewing by the prospective authorized authenticated viewer,
a server with a database on said server for storing the identity authentication information for each prospective authorized authenticated viewer;
a processor configured to perform at least the functions of:
combining (i) the identity authentication information associated with the prospective authorized authenticated viewer with (ii) the electronic file, and
displaying the electronic file with the identity authentication information to the authenticated authorized viewer.

16. The system of claim 15, wherein:
the identity authentication information associated with the prospective authorized authenticated viewer is converted into a cipher, and
a representation of the cipher that is unique to the prospective authorized authenticated viewer is displayed to the authorized authenticated viewer in the form of covert markings that are visible but coded.

17. The system of claim 15, wherein the identity authentication information associated with the prospective authorized authenticated viewer is converted into visible overt markings comprising an authenticated viewer identity string unique to the prospective authorized authenticated viewer.

18. The system of claim 15, wherein
the identity authentication information associated with the prospective authorized authenticated viewer is converted into visible overt markings comprising an authenticated viewer identity string unique to the prospective authorized authenticated viewer.

19. The system of claim 16, wherein the covert markings are represented by at least one of letters, numbers, and symbols having varying sizes, densities, and colors.

20. The system of claim 18, wherein the overt markings are represented by at least one of letters, numbers, and symbols having varying sizes, densities, and colors, wherein the overt markings dynamically float over the electronic file displayed in the viewer.
